(19) United States
(12) Patent Application Publication
(10) Pub. No.: US 2026/0188787 A1
(43) Pub. Date: Jul. 2, 2026

(54) POWERED THERMAL EXCHANGE SYSTEM

(71) Applicant: Polaris Industries Inc., Medina, MN (US)

(72) Inventors: Donald W. Kahl, Blaine, MN (US); John Fox, Wyoming, MN (US); Brent D. Raske, Wyoming, MN (US); Michael W. Rafferty, Wyoming, MN (US); Jason A. Warns, Wyoming, MN (US); Bret H. RempelEwert, Shafer, MN (US)

(21) Appl. No.: 19/434,096

(22) Filed: Dec. 29, 2025

Related U.S. Application Data
(60) Provisional application No. 63/739,988, filed on Dec. 30, 2024.

(51) Int. Cl. H01M 10/6572; H01M 10/44

(52) U.S. Cl. CPC H01M 10/6572; H01M 10/443; H01M 2220/20

(57) ABSTRACT

A powered thermal exchange system includes an energy storage device, a first thermal conductor in thermal communication with the energy storage device, and a thermoelectric device positioned between the energy storage device and the first thermal conductor, the thermoelectric device in conductive thermal communication with the energy storage device and the first thermal conductor, the thermoelectric device configured to receive an electrical power from a power supply and generate a thermal gradient through the thermoelectric device to transfer heat between the energy storage device and the first thermal conductor. The powered thermal exchange system may be used to regulate temperature of the energy storage device. In some forms, the powered thermal exchange system may be used to transfer heat to/from an energy storage device used with a recreational vehicle.

### CROSS-REFERENCE TO RELATED APPLICATIONS

This application claims priority to U.S. Provisional Patent Application 63/739,988 filed Dec. 30, 2024, the entire disclosure is hereby incorporated by reference.

### BACKGROUND

Electric vehicles are generally powered by an on-board energy storage device such as a battery that may be sensitive to environmental conditions. In some energy storage devices, operating the energy storage device at either very low temperature or very high temperature may be detrimental to performance or overall life. For example, discharging the energy storage device during cold starts or charging the energy storage device in hot conditions may place an undue operating burden on the energy storage device. It may also be desired in some operating conditions to provide opportunistic charging of the energy storage device during certain environmental conditions.

### SUMMARY

Aspects of the present disclosure relate to powered thermal exchange systems. Example embodiments include but are not limited to the following embodiments.

In an embodiment of the present disclosure, a powered thermal exchange system is provided. The powered thermal exchange system including: an energy storage device; a first thermal conductor in thermal communication with the energy storage device; and a thermoelectric device positioned between the energy storage device and the first thermal conductor, the thermoelectric device in conductive thermal communication with the energy storage device and the first thermal conductor, the thermoelectric device configured to receive an electrical power from a power supply and generate a thermal gradient through the thermoelectric device to transfer a thermodynamic heat between the energy storage device and the first thermal conductor.

In an example thereof, the powered thermal exchange system further includes a second thermal conductor in conductive thermal communication with the energy storage device, wherein the thermoelectric device is positioned in conductive thermal communication with the second thermal conductor and the first thermal conductor.

In an example thereof, the thermoelectric device in conductive thermal communication with the energy storage device via the second thermal conductor.

In an example thereof, the second thermal conductor includes a graphitic material.

In an example thereof, the graphitic material is graphene.

In an example thereof, the second thermal conductor includes at least one ribbon of the graphitic material.

In an example thereof, the energy storage device includes a plurality of cells and the at least one ribbon is positioned between the plurality of cells.

In an example thereof, the first thermal conductor includes a graphitic material.

In an example thereof, the graphitic material is graphene.

In an example thereof, the power supply is configured to receive power from one of an external power source and the energy storage device.

In an example thereof, the power supply is operatively coupled between the thermoelectric device and the energy storage device.

In an example thereof, the power supply is structured to provide bi-directional power with the thermoelectric device.

In an example thereof, the power supply provides power to the energy storage device through a power bus.

In an example thereof, the power supply is a DC/DC converter, and wherein the power supply is coupled between the thermoelectric device and the power bus, wherein the power bus is electrically coupled between the energy storage device and the DC/DC converter.

In an example thereof, the powered thermal exchange system further includes a power controller configured to regulate operation of the power supply.

In an example thereof, the power controller is configured to operate the power supply based on data indicative of a temperature of the energy storage device.

In an example thereof, the thermoelectric device includes a mode of operation in which the thermodynamic heat is thermoelectrically transferred from the first thermal conductor to the energy storage device.

In an example thereof, the thermoelectric device includes a mode of operation in which the thermodynamic heat is thermoelectrically transferred from the energy storage device to the first thermal conductor.

In an example thereof, in one mode of operation the thermoelectric device is configured to generate an electrical power as a result of the thermal gradient through the thermoelectric device between the energy storage device and the first thermal conductor.

In another embodiment of the present disclosure, a powered thermal exchange system is provided. The powered thermal exchange system includes an energy storage device configured to transmit electrical power, a sealed housing configured to enclose the energy storage device disposed in an interior volume of the sealed housing, the sealed housing structured to prevent transfer of fluid between the interior volume of the sealed housing and an exterior of the sealed housing, and a thermoelectric device in conductive thermal communication with the energy storage device, the thermoelectric device structured to transfer heat between the energy storage device and the exterior of the sealed housing

In an example thereof, the sealed housing is coupled with a pressure vent configured to discharge, during an over-pressure condition of the interior volume of the sealed housing, a fluid from within the interior volume of the sealed housing to the exterior of the sealed housing.

In an example thereof, the pressure vent is a check valve.

In an example thereof, the powered thermal exchange system further includes a first thermal conductor in conductive thermal communication with the exterior of the sealed housing and the thermoelectric device and a second thermal conductor in conductive thermal communication with the energy storage device and the thermoelectric device.

In an example thereof, the second thermal conductor includes a graphitic material.

In an example thereof, the graphitic material is graphene.

In an example thereof, the second thermal conductor includes at least one ribbon of the graphitic material.

In an example thereof, the energy storage device includes a plurality of cells and the at least one ribbon is positioned between the plurality of cells.

In an example thereof, the energy storage device includes a plurality of cells and the at least one ribbon is positioned between the plurality of cells.

In an example thereof, the graphitic material is graphene.

In yet another embodiment of the present disclosure, a method for thermoelectrically transferring heat is provided. The method for thermoelectrically transferring heat includes providing electric power to a thermoelectric device, transferring heat in a first mode of operation from an energy storage device through a wall of a sealed housing to a first thermal conductor as a result of a thermal gradient formed by the providing electric power to the thermoelectric device, removing the transferred heat from the first thermal conductor.

In an example thereof, the transferring includes conductively transferring heat between the energy storage device and the first thermal conductor via the thermoelectric device.

In an example thereof, the method for thermoelectrically transferring further includes conductively transferring the heat between the energy storge device and the thermoelectric device via a second thermal conductor.

In an example thereof, conductively transferring the heat between the energy storge device and the thermoelectric device via a second thermal conductor includes the step of transferring heat through a graphitic material.

In an example thereof, the graphitic material includes graphene.

In an example thereof, transferring the heat through a graphitic material includes transferring heat through a graphene ribbon positioned adjacent at least one cell of the energy storage device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 depicts an embodiment of a powered thermal exchange system in accordance with certain embodiments of the present disclosure.

FIG. 2 depicts a time history of an energy storage device being heated by a thermal electric device of a powered thermal exchange system, in accordance with certain embodiments of the present disclosure

FIG. 3A depicts two scenarios of operation of a powered thermal exchange system in accordance with certain embodiments of the present disclosure.

FIG. 3B depicts two scenarios of operation of a powered thermal exchange system in accordance with certain embodiments of the present disclosure.

FIG. 4 depicts a schematic diagram of a powered thermal exchange system operating in one mode of operation to provide heat transfer in a scenario to heat the energy storage device, in accordance with certain embodiments of the present disclosure.

FIG. 5 depicts a schematic diagram of the powered thermal exchange system of FIG. 1 operating in another mode of operation to provide heat transfer in a scenario to cool the energy storage device, in accordance with embodiments of the present disclosure.

FIG. 6 depicts a schematic diagram of the powered thermal exchange system of FIG. 1 operating in another mode of operation to provide heat transfer in a scenario to heat the energy storage device, in accordance with embodiments of the present disclosure.

FIG. 7 depicts a schematic diagram of the powered thermal exchange system of FIG. 1 operating in another mode of operation to provide a heat transfer in a scenario to cool the energy storage device, in accordance with embodiments of the present disclosure.

FIG. 8 depicts a powered thermal exchange system having a thermal conductor, in accordance with embodiments of the present disclosure.

FIG. 9 depicts a powered thermal exchange system having several thermal conductors, in accordance with embodiments of the present disclosure

FIG. 10 depicts an electrical and thermal schematic of a powered thermal exchange system, in accordance with embodiments of the present disclosure.

FIG. 11 depicts an electrical and thermal schematic of a powered thermal exchange system, in accordance with embodiments of the present disclosure.

FIG. 12 depicts a power controller for use with a powered thermal exchange system, in accordance with embodiments of the present disclosure.

FIG. 13 depicts a flow diagram depicting operation of a powered thermal exchange system, in accordance with embodiments of the present disclosure.

FIG. 14 illustrates a diagram of a computing system for implementing one or more aspects of a powered thermal exchange system, in accordance with embodiments of the present disclosure.

FIG. 15 illustrates an outdoor recreational vehicle having a powered thermal exchange system, in accordance with embodiments of the present disclosure.

FIG. 16 illustrates an outdoor recreational vehicle having a powered thermal exchange system, in accordance with embodiments of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structura99l changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

A powered thermal exchange system is disclosed which includes a thermoelectric device and an energy storage device (e.g., a battery) and in which the thermoelectric device is in conductive thermal communication with the energy storage device to cool and/or heat the energy storage device through conductive heat transfer, where the term ‘heat transfer’ refers to the transfer of thermodynamic heat (e.g., transfer of energy in a thermodynamic system other than thermodynamic work and transfer of matter) and where ‘conductive heat transfer’ refers to heat transfer through conduction as opposed to convection or radiation. In alternative embodiments, the thermoelectric device may be in a heat transfer relationship with the energy storage device via a heat pipe which operate internally on convection, phase change, and mass transfer from one end of the ‘pipe’ to another end of the ‘pipe.’ In some embodiments, the pipe is a closed system such that mass captured internal to the pipe remains internal to the pipe during operation. Examples and embodiments disclosed herein related to conductive heat transfer relationship between the thermoelectric device and energy storage device are thus also applicable to heat transfer relationship between the thermoelectric device and energy storage device through use of a heat pipe. Thus, a system may experience heat transfer to move thermodynamic heat from a first location to a second location such that the first location experiences a rise in temperature (e.g., the first location is heated) or the first location experiences a decrease in temperature (e.g., the first location is cooled). The thermoelectric device is configured to exchange electrical power for heat transfer, and vice versa, in pursuit of regulating a temperature of the energy storage device. In certain modes of operation explained further below, electrical power can be provided to the thermoelectric device to provide heating and/or cooling to the energy storage device, such as when connected to a power supply or charging station. In other modes of operation, the thermoelectric device may generate electrical power resulting in cooling and/or heating of the energy storage device.

As will therefore be appreciated, the thermoelectric device as used herein may be capable of converting temperature differences to electric voltage, and vice versa, and is capable of generating one or more thermoelectric effects including the Seebeck effect, the Peltier effect, and the Thomson effect. In contrast, Joule heating, which includes heat generated whenever a current is passed through a conductive material, is not a thermoelectric effect. Thus, passing current through a resistor to generate resistive heating is not considering a thermoelectric effect, and thus the resistor is not considered a thermoelectric device. The Peltier effect, Seebeck effect, and Thomson effect are thermodynamically reversible, while the Joule effect is not thermodynamically reversible.

The thermoelectric device may be in conductive heat transfer communication with the energy storage device and a heat sink. As mentioned, the temperature of the energy storage device may be regulated through the exchange of electrical power for heat transfer, and vice versa, using any one or more of the thermodynamically reversible effects mentioned herein. Regulating temperature of the energy storage device may be aided through use of a temperature sensor located on, in, or in proximity to the energy storage device. Such a sensor may provide a signal having data indicative of the temperature on, in, or in proximity to the energy storage device. The data indicative of temperature may be provided to a controller configured to control a power supply useful to transmit and/or receive electrical power to/from the thermoelectric device. The controller, in conjunction with the sensor, may be used to control an electrical power delivered to and/or received from the thermoelectric device via the power supply to regulate temperature of the energy storage device. Thus, temperature regulation of the energy storage device may occur through control action of the power supply by the controller of electrical power delivered to and/or received from the thermoelectric device via the power supply based on the data indicative of temperature of the energy storage device provided by the sensor to the controller.

In some embodiments, if data indicative of temperature of the energy storage device is determined by the controller to be below a target temperature, the controller may control the power supply to adjust an amount of power communicated between the thermoelectric device and the power supply such that temperature of the energy storage device is raised. In other embodiments, if data indicative of temperature of the energy storage device is determined by the controller to be above a target temperature, the controller may control the power supply to adjust an amount of power communicated between the thermoelectric device and the power supply such that temperature of the energy storage device is lowered. In some modes of operation, temperature of the energy storage device may be changed (e.g., either raised or lowered) by supplying electrical power from the power supply to the thermoelectric device through control action of the controller. In other modes of operation, temperature of the energy storage device may be changed (e.g., either raised or lowered) by receiving electrical power from the thermoelectric device to the power supply through control action of the controller.

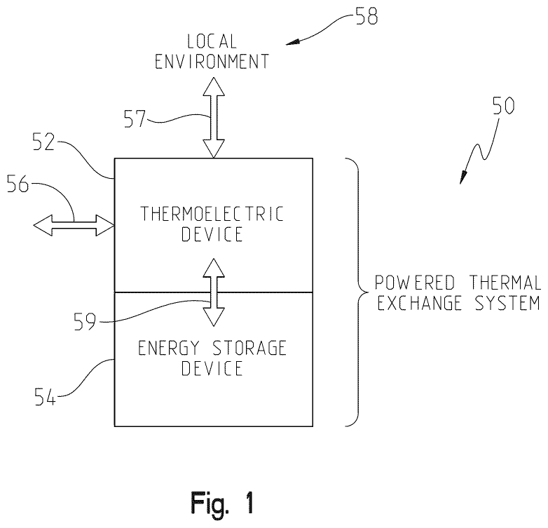

FIG. 1 depicts an embodiment of a powered thermal exchange system 50 having a thermoelectric device 52 that is in thermal communication with an energy storage device 54 and a local environment 58. As described herein, thermal communication includes a heat transfer relationship where the term ‘heat transfer’ refers to the transfer of thermodynamic heat (e.g., transfer of energy in a thermodynamic system other than thermodynamic work and transfer of matter) using any of conduction, convection, or radiation unless otherwise specified. Thermoelectric device 52 in general refers to a device of the type mentioned above (e.g., a device capable of producing a thermodynamically reversible process that involves any one or more of the Seebeck effect, the Peltier effect, and the Thomson effect) capable of generating a temperature difference from one side of thermoelectric device 52 to another side of thermoelectric device 52 based on an electric potential applied to thermoelectric device 52 and/or a device capable of generating an electric potential based on a temperature difference between one side of thermoelectric device 52 and another side of thermoelectric device 52. Electrical power 56 can therefore be provided to and/or generated from thermoelectric device 52 with an accompanying heat transfer 57 between one side of thermoelectric device 52 and local environment 58, as well as an accompanying heat transfer 59 between another side of thermoelectric device 52 and energy storage device 54. Energy storage device 54 is therefore in thermal communication (e.g., in a heat transfer relationship) with local environment 58 via thermoelectric device 52 such that heat may flow between energy storage device 54 and local environment 58. As will be described further herein, powered thermal exchange system 50 can be operated in a number of different modes to provide an exchange of electrical power 56 and heat transfer 57 in several different scenarios, examples of which are described further hereinbelow.

Thermoelectric device 52 may take a variety of forms useful to exchange electrical power for thermal energy, and vice versa, to aid in providing thermal management for the energy storage device 54. For example, thermoelectric device 52 may take the form of a Peltier device, Peltier heat pump, solid state refrigerator, or thermoelectric cooler, among potential others. The operative material used in thermoelectric device 52 to provide the thermodynamically reversible process that involves any one or more of the Seebeck effect, the Peltier effect, and the Thomson effect may take a variety of forms including alloys, crystals, and multiphase nanocomposites. In some embodiments, the operative material in the thermoelectric device 52 may include bismuth telluride. Other materials are also contemplated. For example, the operative material used in thermoelectric device 52 may include lead tellurides, inorganic clathrates, skutterudite thermoelectrics, half-Heusler alloys, electrically conducting organic materials, hybrid composites, sodium cobaltate, etc.

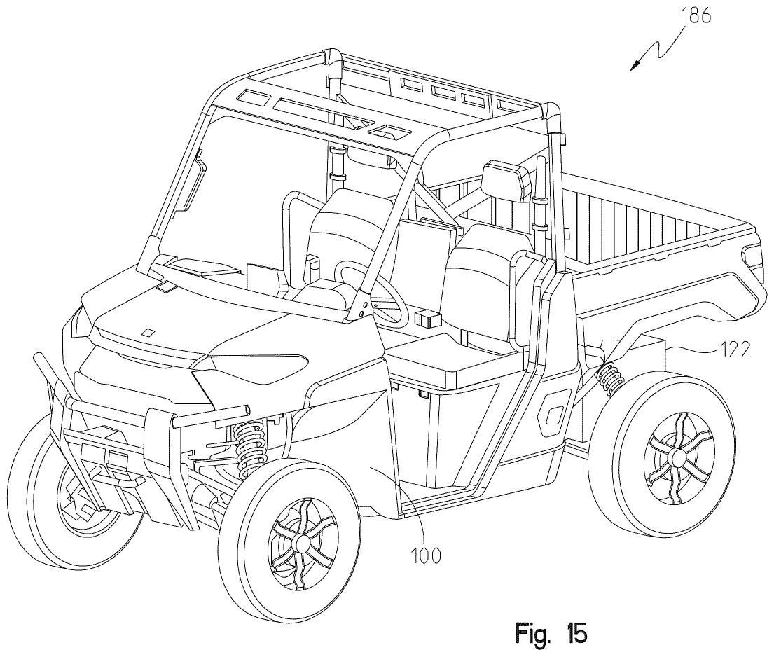

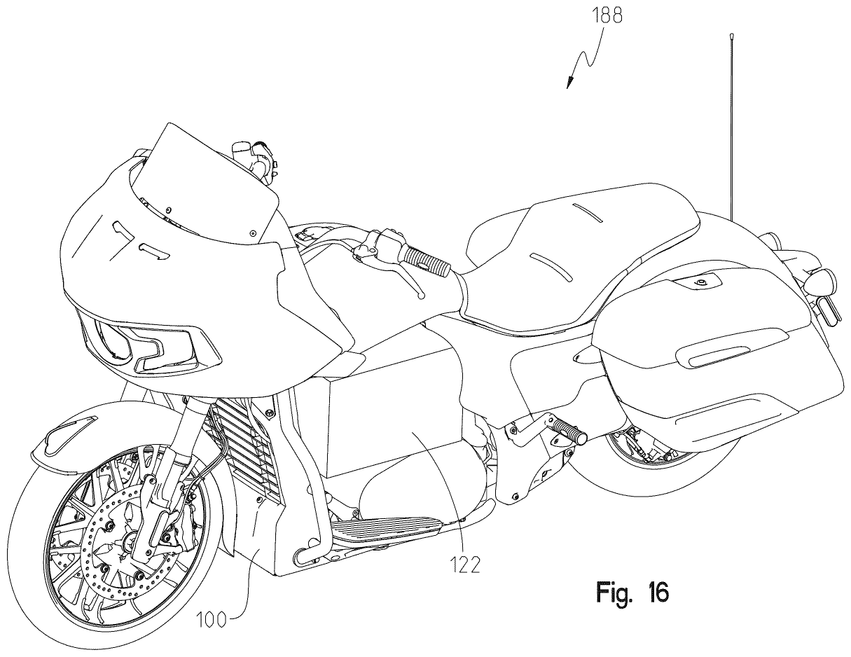

Energy storage device 54 may take a variety of forms useful to provide and/or receive electrical power in the operation of, for example, an electric vehicle. In one form, energy storage device 54 provides motive power to the electric vehicle, while in other forms energy storage device 54 may supplement motive power to the electric vehicle provided by a different energy source, in which the supplemental power is used to provide electrical power to one or more vehicle accessories. In still other forms, energy storage device 54 may provide both motive power and accessory power. For example, energy storage device 54 may be used to provide power to a powertrain of the vehicle and/or provide power to accessories of the vehicle such as a radio, speakers, horn, turn blinker, headlamp, brake light, etc. In some embodiments, the electric vehicle may be an outdoor recreational vehicle such as a motorcycle. Other outdoor recreational vehicles are also contemplated such as off-road all-terrain vehicles, boats, etc. FIGS. 15 and 16 illustrate two embodiments of recreational vehicles.

In some embodiments, a chemical potential of energy storage device 54 (e.g., the potential for a chemical reaction to occur and release electrical energy when the energy storage device 54 is discharged) is influenced by a temperature of the energy storage device 54. For example, the chemical potential of energy storage device 54 may be lower (e.g., chemical reactions in the energy storage device 54 may be lower, thus resulting in a decreased ability to generate electrical power) when the energy storage device 54 is at a temperature lower than an ideal operating temperature. Operation of energy storage device 54 at a temperature lower than an ideal operating temperature may result in an inability of energy storage device 54 to provide necessary power. The chemical potential of energy storage device 54 may be higher (e.g., chemical reactions in the energy storage device 54 may be increased, thus resulting in accelerated component deterioration) when the energy storage device 54 is at a temperature higher than an ideal operating temperature. Operation of energy storage device 54 at a temperature higher than an ideal operating temperature may damage energy storage device 54 leading to a faster discharge in future operations, reduced capacity, and/or a shortened lifespan.

Energy storage device 54 may take the form of any one or more of various batteries capable of providing electrical voltages suitable for electric vehicles. Output voltages contemplated for energy storage device 54 include 12 Volts (V), 48V, 100V, 400V, and 600V. The battery may have any variety of battery chemistries, including lithium-ion, nickel-cadmium, nickel-metal, lead-acid, nickel-zinc, lithium-ion polymer, etc. Furthermore, energy storage device 54 can include one or more energy storage cells that may be configured to operate together. For example, energy storage device may include several cells arranged in electrical series to provide an increase in voltage relative to cells arranged in parallel. Energy storage device may also include several cells arranged in parallel to provide an increase in total capacity while maintaining an overall voltage.

Local environment 58 may take a variety of forms in any given application, including gaseous and liquid, and in which is generally characterized by a pressure and a temperature which influences heat transfer to and/or from powered thermal exchange system 50. Local environment 58 may include general atmospheric conditions associated with an outside environment. For example, local environment 58 may refer to local outside air conditions such as those associated with a cold winter day, a hot summer day, a standard day, a hot and humid day, etc. Local environment 58 may also be an environment in a compartment of a vehicle. It is contemplated that powered thermal exchange system 50 may be used in a variety of vehicles including planes, boats, trains, automobiles, snowmobiles, all-terrain vehicles, and motorcycles. In some applications of powered thermal exchange system 50, local environment 58 may refer to a glovebox in a vehicle, an engine compartment in a vehicle, etc., In still further examples, local environment 58 may refer to an environment inside of a building, where the environment may or may not be controlled (e.g., a heated garage in the winter, an air conditioned high bay in the summer, etc.).

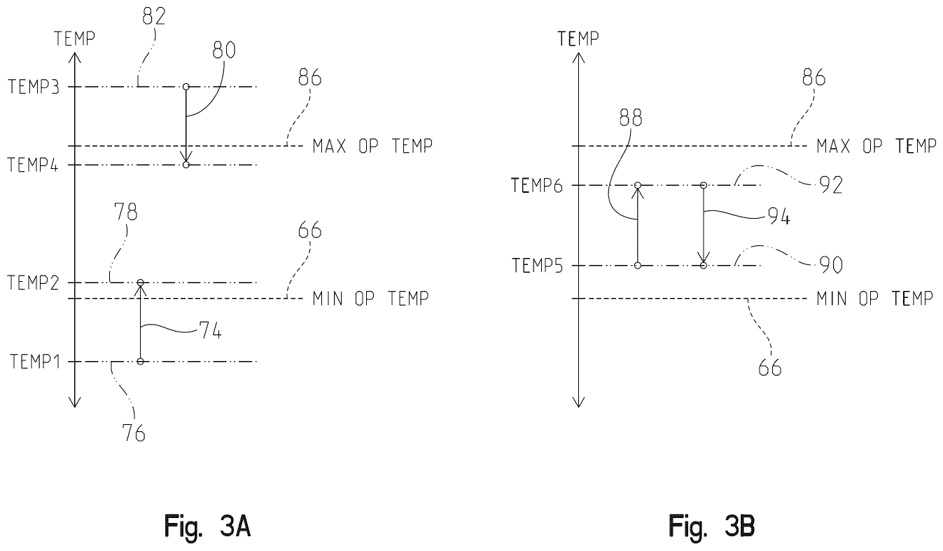

As discussed above, thermoelectric device 52 may be used to provide thermal management for the energy storage device 54. FIGS. 3, 3A, and 3B depict various modes of operating thermoelectric device 52 to provide thermal management for the energy storage device 54.

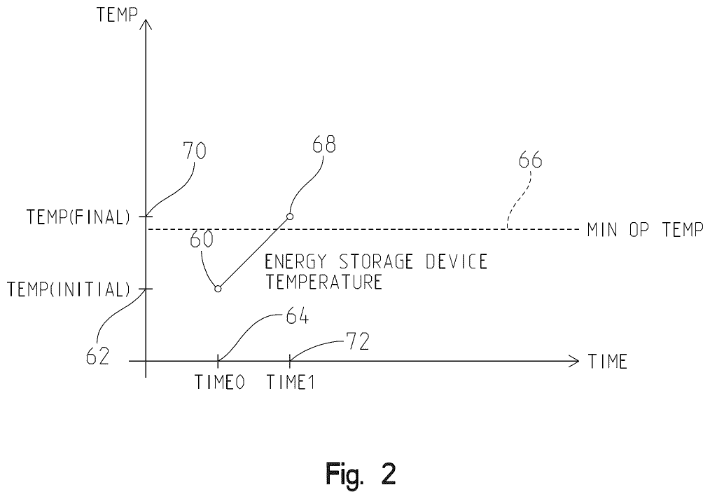

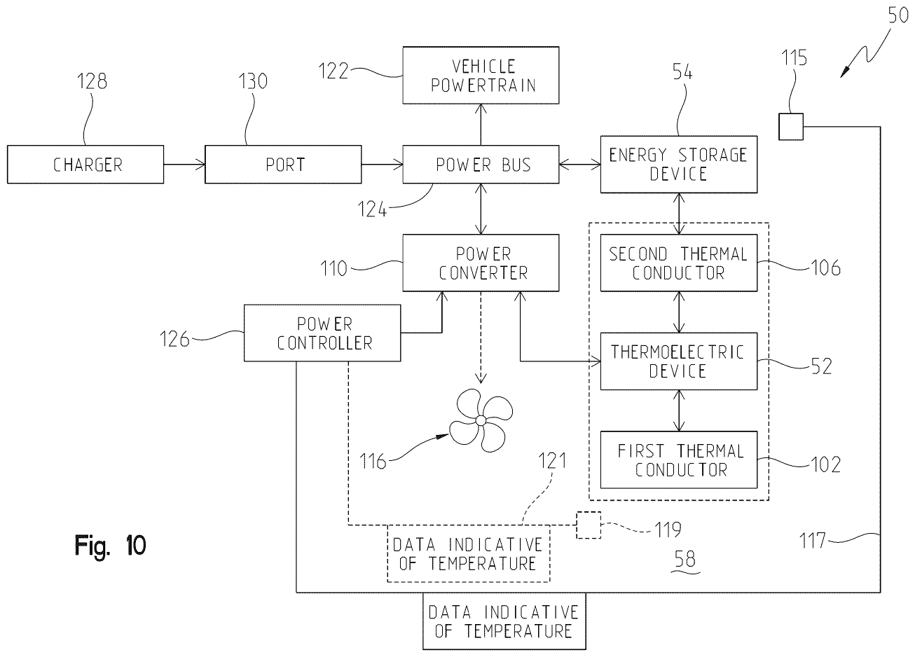

FIG. 2 depicts a temperature change of the energy storage device 54 of the powered thermal exchange system 50 that is in thermal communication with the thermoelectric device 52 of the powered thermal exchange system 50. FIG. 2 illustrates a mode of operation in which a temperature of the energy storage device 54 is initially below an operating threshold but in which the thermoelectric device 52 is used to raise the temperature of energy storage device 54. Such a mode of operation can be used, for example, when energy storage device 54 has become cold-soaked as a result of being stored at a low temperature. A cold-soaked energy storage device 54 may result in lower chemical potential of the energy storage device 54 and potential inability to provide sufficient electrical power. Lower chemical potential will produce lower electrical power output available from energy storage device 54. Energy storage device 54 in the example provided in FIG. 2 is heated by the thermoelectric device 52 from an initial condition 60 having initial temperature 62 at an initial time 64 that is below a minimum operating temperature 66, to a final condition 68 having a final temperature 70 above minimum operating temperature 66 at a final time 72 which is above the minimum operating temperature 66. In some embodiments, the minimum operating temperature 66 is a temperature below which electrical power from energy storage device 54 may be less than a desired value (e.g., a value in which the energy storage device 54 is sized to provide adequate power to drive one or more aspects of thermal exchange system 50 and/or one or more aspects of a vehicle powertrain such as vehicle powertrain 122 discussed in FIG. 10).

Though the mode of operation depicted in FIG. 2 provides electrical power 56 to a thermoelectric device so that heat transfer 57 may be used to heat a cold energy storage device, embodiments of the powered thermal exchange system 50 may be used in different modes of operation. The different modes of operation can generally be categorized according to whether electrical power 56 is consumed or generated by the thermoelectric device 52, and whether heat transfer 57 occurs to or from the energy storage device 54. Each of these modes of operation of the powered thermal exchange system 50 may be exercised in various scenarios. Consider a battery that has a desired operational range of 50 degrees to 110 degrees Fahrenheit; thermal exchange may be used to bring the battery temperature within (and maintain) the desired temperature range. For example, a cold energy storage device 54 being used in a cold local environment 58 (e.g., below 50 degrees) may be heated, in which a mode of operation involves providing electrical power 56 to the thermoelectric device 52 to transfer heat to the energy storage device 54. In another scenario, a warm energy storage device 54 being used in a cooler local environment 58 may be cooled from its warm condition (e.g., above 110 degrees Fahrenheit), in which a mode of operation involves generating electrical power 56 as a result of heat transfer 57 occurring from the energy storage device 54 to the cold local environment 58.

FIGS. 3A and 3B illustrate several different scenarios of use of the powered thermal exchange system 50. FIG. 3A depicts two scenarios in which electrical power 56 is provided to and consumed by the thermoelectric device 52. FIG. 3B depicts another two scenarios in which electrical power 56 is generated by the thermoelectric device 52.

Referring now to FIG. 3A, a first scenario 74 depicts providing electrical power 56 to the thermoelectric device 52 to heat the energy storage device 54 from an initial temperature 76 to a final temperature 78 above the minimum operating temperature 66. First scenario 74 may be encountered when warming the energy storage device 54 on a cold day (e.g., below 32 degrees Fahrenheit) in which environmental conditions of local environment 58 drive a temperature of the energy storage device 54 below minimum operating temperature 66 prior to operating the energy storage device 54. First scenario 74 thus depicts consuming electric power 56 by the thermoelectric device 52 to provide heat transfer 57 from local environment 58 to energy storage device 54 to create and maintain a thermal gradient between the energy storge device 54 and a temperature of the local environment 58. As will be appreciated, a thermal gradient is a difference of temperature over a given distance. Here, the thermal gradient may be actively controlled to maintain e.g., a minimum operating temperature, a maximum operating temperature, etc. The minimum operating temperature may be a low threshold of a rated temperature range for energy storage device 54 or may be a low threshold temperature selected by the vehicle manufacturer for desired vehicle performance.

A second scenario 80 depicts providing electrical power 56 to the thermoelectric device 52 to cool the energy storage device 54 from an initial temperature 82 to a final temperature 84 below a maximum operating temperature 86. Second scenario 80 may be encountered when exposing the energy storage device 54 to a hot day in which environmental conditions of local environment 58 drives a temperature of the energy storage device 54 above maximum operating temperature 86 prior to operating the energy storage device 54. Second scenario 80 thus depicts consuming electric power 56 by the thermoelectric device 52 to provide heat transfer 57 from energy storge device 54 to local environment 58 to create and maintain a thermal gradient between the energy storge device 54 and a temperature of the local environment 58. Maximum operating temperature may be a high threshold of a rated temperature range for energy storage device 54 or may be a high threshold temperature selected by the vehicle manufacturer for desired vehicle performance. Electrical power may be continually supplied to thermoelectric device 54 keep temperature of thermoelectric device 54 at or below a desired level (e.g., at or below maximum operating temperature 86), as when the energy storage device 54 is being heated, for example, during a charging condition.

Referring now to FIG. 3B, a third scenario 88 depicts generating electrical power 56 from the thermoelectric device 52 to heat the energy storage device 54 from temperature 90 to temperature 92. Third scenario 88 may be encountered when the energy storage device 54 is cold but in which current conditions of local environmental 58 result in a temperature of the local environment 58 being warmer that energy storage device 54. Such a scenario may occur when moving the powered thermal exchange system 50 from a cool local environment 58 at temperature 90 to a warm local environment 58 at temperature 92 (e.g., moving the powered thermal exchange system 50 from indoors to outdoors on a hot summer day). Electric power 56 may be generated by the thermoelectric device 52 as it warms the energy storage device 54 to take advantage of a thermal gradient between the energy storage device 54 and the local environment 58. Here, the thermal gradient may be converted to electrical energy for harvesting. It is contemplated that electrical power 56 may be generated when operating between the minimum operating temperature 66 and maximum operating temperature 86. Third scenario 88 thus depicts generating electric power 56 with the thermoelectric device to provide heat transfer 57 from local environment 58 to energy storage device 54 as heat flows in the direction of the thermal gradient between local environment 58 and energy storage device 54. The electrical power created due to the thermal gradient may be used charge the energy storage device 54 as is described elsewhere herein.

A fourth scenario 94 depicts generating electrical power 56 from the thermoelectric device 52 to cool the energy storage device 54 from temperature 92 to temperature 90. Fourth scenario 94 may be encountered when the energy storage device 54 is hot but in which current conditions of local environmental 58 result in a temperature of the local environment 58 being cooler than energy storage device 54. Such a scenario may occur when moving the powered thermal exchange system 50 from a warm local environment 58 (e.g., 100 degrees Fahrenheit) to a cool local environment 58 (e.g., 70 degrees Fahrenheit) (e.g., moving the powered thermal exchange system 50 from indoors to outdoors on a cold winter day, or during discharge of energy storage device 54 in a cooler environment). Electric power 56 may be generated by the thermoelectric device 52 as it cools the energy storage device 54 to take advantage of a natural thermal gradient between the energy storage device 54 and the local environment 58. It is contemplated that electrical power 56 may be generated when operating between the minimum operating temperature 66 and maximum operating temperature 86. Fourth scenario 94 thus depicts generating electrical power 56 with the thermoelectric device 52 to provide heat transfer 57 from energy storage device 54 to local environment 58 as heat flows in the direction of the thermal gradient between energy storage device 54 and local environment 58.

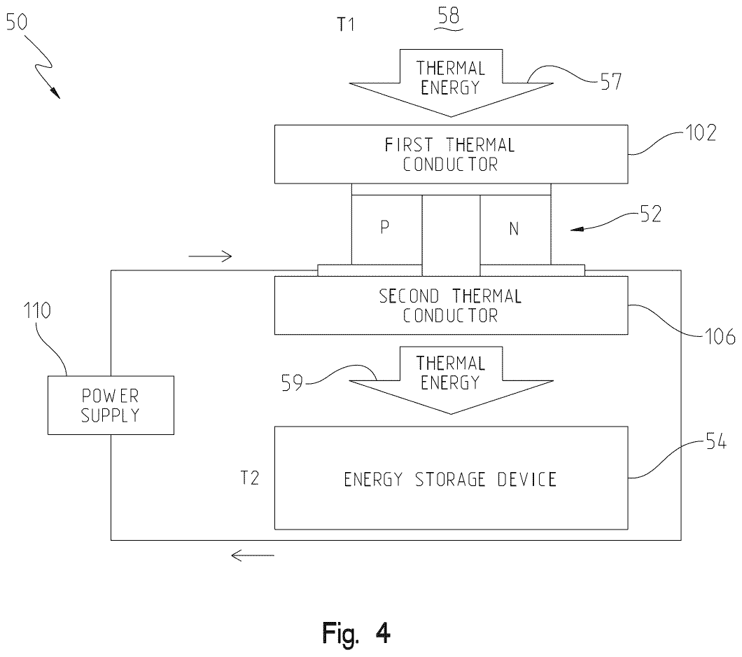

FIGS. 4-7 depicts block diagrams illustrating different scenarios in which the powered thermal exchange system 50 is used in different modes to convert between electric power and heat transfer as it relates to regulating a temperature of an energy storage device 54. In the modes of operation depicted in FIGS. 4-7, thermoelectric device 52 is schematically depicted having a simple p-n junction, but no limitation is intended regarding the arrangement and/or composition of junction.

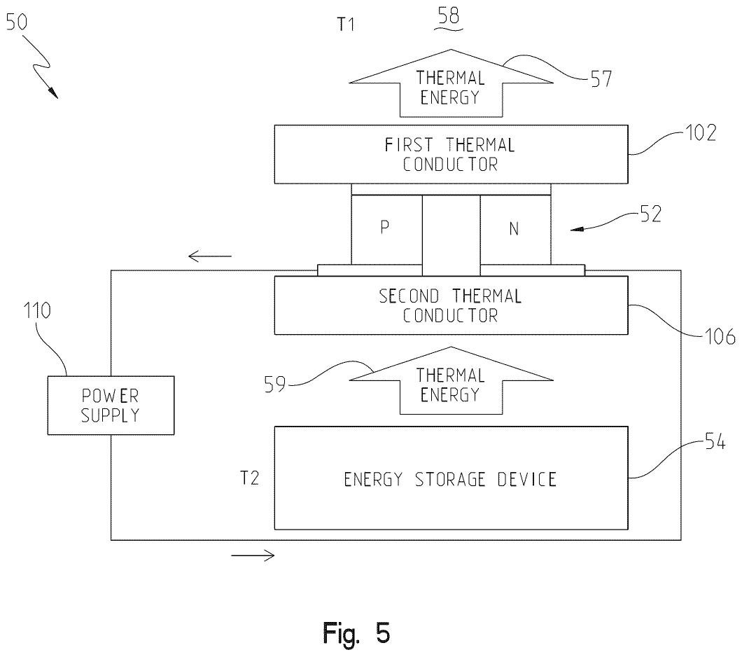

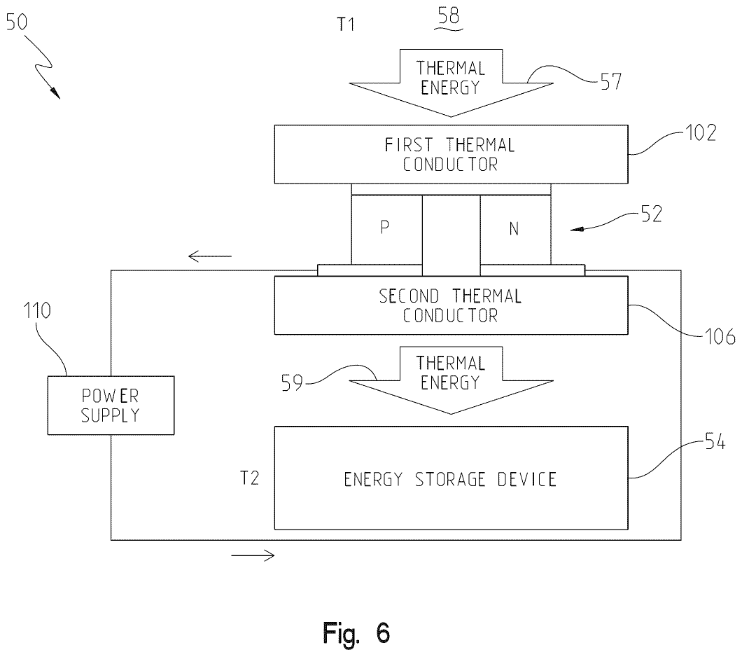

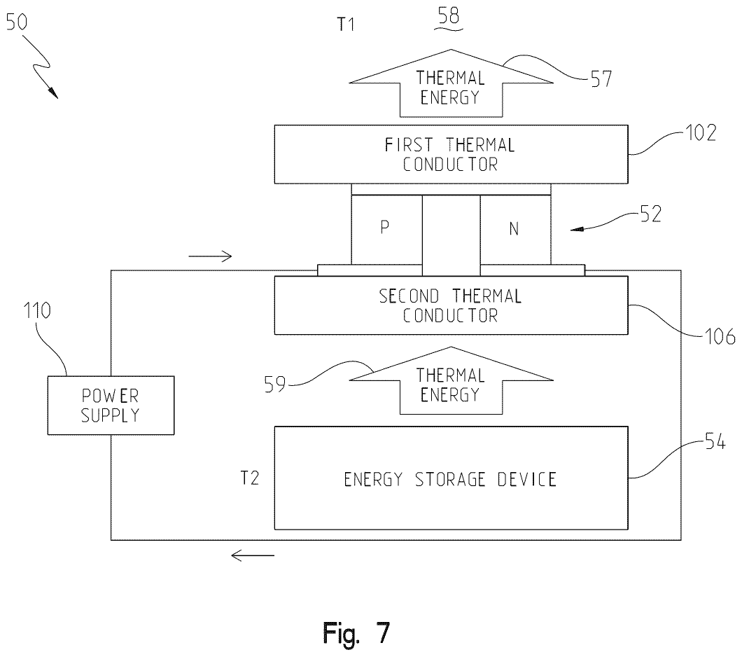

FIG. 4 depicts powered thermal exchange system 50 in a scenario akin to scenario 74 from FIG. 3A in which electrical power is provided to thermoelectric device 52 to heat the energy storage device 54 in case of cold weather conditions. FIG. 5 depicts powered thermal exchange system 50 in a scenario akin to scenario 80 from FIG. 3A in which electrical power is provided to thermoelectric device 52 to cool the energy storage device 54 in case of warm weather conditions or after use. FIG. 6 depicts powered thermal exchange system 50 in a scenario akin to scenario 88 in FIG. 3B in which electrical power is generated by thermoelectric device 52 which results in an increase in temperature of energy storage device 54. FIG. 7 depicts powered thermal exchange system 50 in a scenario akin to scenario 94 in FIG. 3B in which electrical power is generated by thermoelectric device 52 which results in a decrease in temperature of the energy storage device 54.

FIGS. 4-7 include thermoelectric device 52 in thermal communication between local environment 58 via a first thermal conductor 102 and energy storage device 54 via a second thermal conductor 106. Thermoelectric device 52 is also operatively coupled with power supply 110 (e.g., thermoelectric device 52 is in electrical communication with a power supply 110). First thermal conductor 102 and/or second thermal conductor 106 are used to conduct heat within powered thermal exchange system 50. For example, first thermal conductor 102 is used, as described above, to transfer heat between local environment 58 of first thermal conductor 102 and thermoelectric device 52, while second thermal conductor 106 is used to transfer heat between thermoelectric device 52 and energy storage device 54. First thermal conductor 102 and/or second thermal conductor 106 may be made from a variety of materials and constructions useful to transfer heat within powered thermal exchange system 50 as well as transfer heat to/from local environment 58 in which powered thermal exchange system 50 is operated. Each of first thermal conductor 102 and second thermal conductor 106 may be similar in materials and construction, but some embodiments contemplate different material and/or construction for first thermal conductor 102 and second thermal conductor 106. First thermal conductor 102 and/or second thermal conductor 106 may take a variety of forms, including: a monolithic material; an integrated device comprised of different components fastened and/or affixed together to form an integrated construction; segmented but otherwise separate devices that are not fastened and/or affixed together, a composite material, etc. In some embodiments, first thermal conductor 102 and/or second thermal conductor 106 may be a copper plate. In other embodiments, first thermal conductor 102 and/or second thermal conductor 106 may be made from graphitic materials (e.g., graphite, graphene, carbon nanotubes, graphene ribbon, etc.). It will be appreciated that some materials provide relatively higher thermal conductivity than other materials. For example, given the relative conductivity of graphitic materials and copper (to set forth just one example among many of the various types of materials that may be used with first thermal conductor 102 and second thermal conductor 106), providing either or both of first thermal conductor 102 and second thermal conductor 106 in the form of graphitic material may provide a more compact form factor to provide the same heat transfer as copper. Thus, powered thermal exchange system 50 may be made relatively smaller when using graphitic materials for powered thermal exchange system 50 than when using copper for powered thermal exchange system 50. Each of first thermal conductor 102 and thermoelectric device 52 is constructed to transfer heat using any one or more of conduction, convection, and radiation. For example, though first thermal conductor 102 may provide conductive heat transfer with thermoelectric device 52, in some forms first thermal conductor 102 may also provide convection and/or radiation heat transfer to other media (e.g., to an air that circulates in proximity to thermoelectric device 52). To set forth another example, while second thermal conductor 106 may provide conductive heat transfer to energy storage device 54, in some forms second thermal conductor 106 may also provide convection and/or radiation heat transfer to other media (e.g., to an air that circulates in proximity to energy storage device 54). It will be appreciated that heat transfer through convection and/or radiation may be accomplished through heat transfer elements such as radiator fins. For example, either or both of first thermal conductor 102 and second thermal conductor 106 may be formed of a material (e.g., graphitic material, copper, etc.) and in a shape that provides radiator fins.

Power supply 110 is configured to provide electrical power (e.g., electrical power 56 depicted in FIG. 1) to and/or receive electrical power from thermoelectric device 52. In one embodiment, power supply 110 supplies and/or receives direct current (DC) power to thermoelectric device 52. Power supply 110 may be sized to provide a wide range of voltage and current to thermoelectric device 52. In one embodiment, the power provided by power supply 110 may be regulated by a controller. In another embodiment, power supply 110 may be operatively coupled with a power source (e.g., power supply 110 may be in electrical communication with a power source). Such a power source may include power from a grid (e.g., 110V and/or 220V available in residential homes and commercial establishments or charging stations (e.g., fast chargers) and/or may include power from an energy storage device similar to embodiments of energy storage device 54. It will be appreciated that power sources in the form of a grid (e.g., 110V and/or 220V) may not be affected in the same manner by temperature as energy storage device 54 as discussed elsewhere herein. In one embodiment, power supply 110 receives electrical power from the energy storage device 54. In such an embodiment, power supply 110 will be affected in by temperature driven impacts to energy storage device 54, in which case maintaining temperature of energy storage device 54 relative to a temperature threshold (e.g., maximum operating temperature 86 and/or minimum operating temperature 66) may be desired. In some embodiments, power supply 110 may be a DC/DC converter used to provide DC power to thermoelectric device 52, where the DC power provided to thermoelectric device 52 is the result of a power conversion from an electrical power provided from a power source.

Turning now specifically to FIG. 4, powered thermal exchange system 50 is depicted as being used to transfer heat from local environment 58 to energy storage device 54 in a scenario akin to scenario 74 in FIG. 3A of operating energy storage device 54 in cold temperatures. A heat transfer path is present in the embodiment of FIG. 4 from local environment 58 to the first thermal conductor 102, wherein first thermal conductor 102 is in heat transfer communication with a first side of a thermoelectric device 52. As will be appreciated, a heat transfer path is a path along which heat flows (e.g., a path that includes first thermal conductor 102 and thermoelectric device 52, but other heat transfer paths also exist such as first thermal conductor 102, thermoelectric device 52, second thermal conductor 106, and energy storage device 54) and which may be used to increase, or decrease, or maintain the same, a temperature of a component (e.g., any component in the heat transfer path such as first thermal conductor 102, thermoelectric device 52, second thermal conductor 106, and energy storage device 54) along the path. The heat transfer path continues through thermoelectric device 52, and to second thermal conductor 106 which is in heat transfer communication with a second side opposite the first side of thermoelectric device 52. The energy storage device 54 is in conductive thermal communication with second thermal conductor 106. In the illustration of FIG. 4, a temperature T2 represents a temperature of energy storage device 54, and a temperature T1 represents a temperature of local environment 58. FIG. 4 depicts first thermal conductor 102 as absorbing heat from local environment 58, whether that be through conduction, convection, radiation, or any combination thereof. In the scenario depicted in FIG. 4, first thermal conductor 102 is in relatively cool local environment 58 which requires a power supply 110 to provide electrical power 56 to thermoelectric device 52 so that thermoelectric device 52 may generate a thermal gradient useful to move heat from local environment 58 to energy storage device 54. FIG. 4 also describes a situation in which powered thermal exchange system 50 is cold-soaked such that at the beginning of operation T2=T1, both of which may be below minimum operating temperature 66. Active thermal transfer pulls heat from the local environment 58 (cooling T1 even further), to heat up the second thermal conductor 106 in heat transfer communication with energy storage device 54. The process of moving heat from local environment 58 to energy storage device 54 may continue until T2 is increased above minimum operating temperature 66. Generation of a thermal gradient by thermoelectric device 52 raises temperature T2 above T1 and/or maintains temperature T2 above temperature T1. As with scenario 74 in FIG. 3A, powered thermal exchange system 50 may be operated in FIG. 4 in situations in which it is desired to raise temperature T2 of energy storage device 54 above minimum temperature threshold 66 (FIG. 3A), or maintain temperature T2 above minimum temperature threshold 66 (FIG. 3A).

FIG. 5 depicts powered thermal exchange system 50 being used to transfer heat from energy storage device 54 to local environment 58 in a scenario akin to scenario 80 in FIG. 3A of operating energy storage device 54 in warm temperatures, or when energy storage device 54 exceeds or approaches a temperature limit (e.g., maximum operating temperature 86). A conductive heat transfer path is present in the embodiment of FIG. 5 from energy storage device 54 to second thermal conductor 106, wherein the second thermal conductor 106 is in heat transfer communication with the second side of thermoelectric device 52. The heat transfer path continues through thermoelectric device 52, and to first thermal conductor 102 which is in heat transfer communication with the first side opposite the second side of thermoelectric device 52. First thermal conductor 102 is in thermal communication with local environment 58, whether that be through conduction, convection, radiation, or any combination thereof. Heat is thus removed from first thermal conductor 102 to local environment 58 (or in other words, thermal communication of first thermal conductor 102 with local environment 58 results in removing heat transferred from the second thermal conductor 106). In the illustration of FIG. 5, a temperature T2 represents a temperature of energy storage device 54, and a temperature T1 represents a temperature of local environment 58. In the scenario depicted in FIG. 5, first thermal conductor 102 is in relatively warm local environment 58 which requires a power supply 110 to provide electrical power 56 to thermoelectric device 52 so that thermoelectric device 52 may generate a thermal gradient useful to move heat from energy storage device 54 to local environment 58 (e.g., to reduce T2 below maximum operating temperature 86). Generation of a thermal gradient by thermoelectric device 52 lowers temperature T2 below T1 and/or maintains temperature T2 below temperature T1. As with scenario 80 in FIG. 3A, powered thermal exchange system 50 may be operated in FIG. 5 in situations in which it is desired to lower temperature T2 of energy storage device 54 below maximum temperature threshold 86 (FIG. 3A), or maintain temperature T2 below the maximum temperature threshold 86 (FIG. 3A).

FIG. 6 depicts powered thermal exchange system 50 being used to transfer heat from local environment 58 to energy storage device 54 in a scenario akin to scenario 88 in FIG. 3B of operating energy storage device 54. A heat transfer path is present in the embodiment of FIG. 6 from local environment 58 to the first thermal conductor 102, wherein first thermal conductor 102 is in heat transfer communication with a first side of a thermoelectric device 52. The heat transfer path continues through thermoelectric device 52, and to second thermal conductor 106 which is in heat transfer communication with a second side opposite the first side of thermoelectric device 52. The energy storage device 54 is in conductive thermal communication with second thermal conductor 106. In the illustration of FIG. 6, a temperature T2 represents a temperature of energy storage device 54, and a temperature T1 represents a temperature of local environment 58. FIG. 6 depicts first thermal conductor 102 as absorbing heat from local environment 58, whether that be through conduction, convection, radiation, or any combination thereof. The mode of operation of FIG. 6 may be used in situations in which it is desired to generate electrical power owing to a difference between temperature T2 of energy storage device 54 and temperature T1 of local environment 58 (e.g., through use of the Seebeck effect). Such a mode may be used, for example, in environments in which energy storage device 54 is below a maximum temperature threshold and in which energy storage device 54 is at a lower temperature T2 than temperature T1 of local environment 58. Such a scenario may occur when moving powered thermal exchange system 50 from a cool first local environment 58 in which powered thermal exchange system 50 may have cold soaked and to a relatively warm second local environment 58 in which temperature T1 increases. For example, moving a vehicle having powered thermal exchange system 50 from a relatively cool first local environment 58 to a relatively warm second local environment 58 in which T1 increases before T2 increases (e.g., thermal mass of energy storage device 54 causes temperature T2 to lag behind the change in temperature T1). This provides an opportunity to use the mode described in FIG. 6 in which electrical power is generated by thermoelectric device 52 owing to a difference between temperature T1 and temperature T2.

FIG. 7 depicts powered thermal exchange system 50 being used to transfer heat from energy storage device 54 to local environment 58 in a scenario akin to scenario 94 in FIG. 3B. A conductive heat transfer path is present in the embodiment of FIG. 5 from energy storage device 54 to second thermal conductor 106, wherein the second thermal conductor 106 is in heat transfer communication with the second side of thermoelectric device 52. The heat transfer path continues through thermoelectric device 52, and to first thermal conductor 102 which is in heat transfer communication with the first side opposite the second side of thermoelectric device 52. First thermal conductor 102 is in thermal communication with local environment 58, whether that be through conduction, convection, radiation, or any combination thereof. The mode of operation of FIG. 7 may be used in situations in which it is desired to generate electrical power owing to a difference between temperature T2 of energy storage device 54 and temperature T1 of local environment 58. Such a mode may be used, for example, in environments in which energy storage device 54 is below maximum operating temperature threshold 86 (FIG. 3B) and in which energy storage device 54 is at a higher temperature than temperature T1. Such a scenario may occur when moving powered thermal exchange system 50 from a relatively warm first local environment 58 in which T2 may have reached equilibrium with relatively warm T1 to a relatively cool second local environment 58 or when operation of the vehicle has caused a rise in the temperature T2 of energy storage device 54 above the temperature T1 of the local environment. For example, moving a vehicle having powered thermal exchange system 50 from a relatively warm first local environment 58 to a relatively cool second local environment 58 in which T1 decreases provides an opportunity to use the mode described in FIG. 7 in which electrical power is generated by thermoelectric device 52 owing to a difference between temperature T1 of the second local environment 58 and temperature T2 of energy storage device 54.

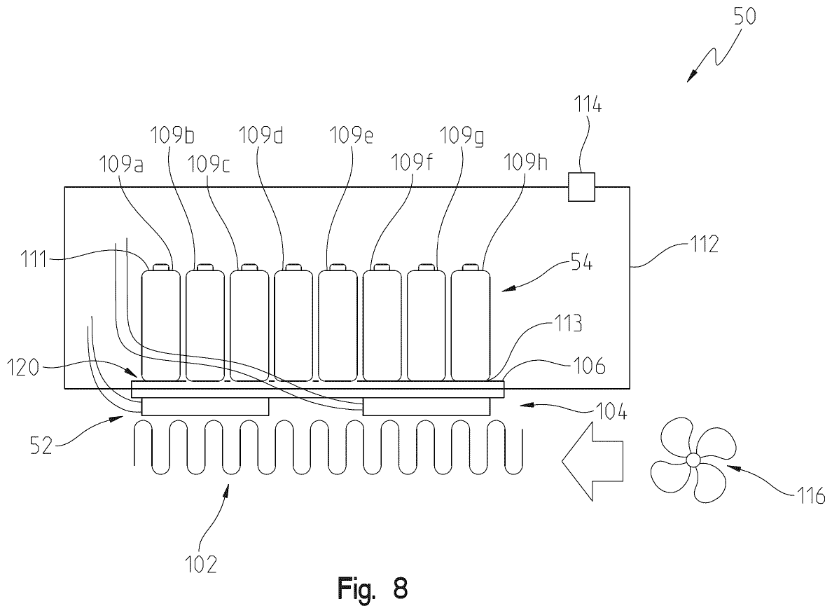

Turning now to FIG. 8, an embodiment of powered thermal exchange system 50 is illustrated at least partially enclosed in a housing 112, where such housing may be mounted to, for example, a vehicle. As illustrated, housing 112 encloses energy storage device 54 and at least part of second thermal conductor 106, where another part of second thermal conductor 106, thermoelectric device 52, and first thermal conductor 102 are located external to housing 112. Housing 112 may be used to protect energy storage device 54 from external debris on an exterior of the housing 112, protect energy storage device 54 from contact with harmful objects, and/or provide for an enclosed environment to protect personnel such as operators of a vehicle. Housing 112 may provide a hermetic seal to enclose energy storage device 54 to prevent transfer of fluid, such as air and/or water, between the exterior of the housing 112 and the interior of the housing 112. In the illustrated embodiment, housing 112 includes a vent 114 that may include a closed position and an open position. The vent 114 may be a pressure relief vent that moves from the closed position to the open position only when an internal pressure of the housing 112 exceeds an opening pressure. The open position may be used to allow venting of fluid in the case of discharge of same from energy storage device 54. Vent 114, therefore, may act as a safety mechanism in furtherance of protecting an operator of a vehicle. Vent 114 may take a variety of forms, including a check valve that is spring biased to the closed position but that may be opened if pressure within housing 112 rises above a an opening pressure. In some embodiments, vent 114 may be electronic and opened if a pressure sensor internal to housing 112 senses a pressure above a pressure threshold which may be the same as the opening pressure in the case of a check valve. In one embodiment, the closed position of vent 114 may be utilized when maintaining a hermetic seal of housing 112. Whether housing 112 provides a hermetic seal or includes a vent 114, enclosing energy storage device 54 within housing 112 may limit the ability to effectively transfer heat to/from energy storage device 54. For example, housing 112 may limit the ability of energy storage device 54 to be convectively cooled by a fluid (e.g., air or water) and/or conductively cooled through a wall of housing 112. In such situations, T2 may exceed either of maximum operating temperature 86 or minimum operating temperature 66. Use of thermal exchange system 50 can aid in lowering or raising T2 of energy storage device 54 within either of maximum operating temperature 86 or minimum operating temperature 66 as described herein.

As illustrated, second thermal conductor 106 is positioned through a wall of housing 112 and serves to transfer heat between energy storage device 54 and thermoelectric device 52. In some embodiments, second thermal conductor 106 may be integrally formed in the wall of housing 112. In other embodiments, second thermal conductor 106 may be integrated into the wall of housing 112. For example, second thermal conductor 106 may be inserted into an aperture of the wall of housing 112 and affixed in place.

FIG. 8 depicts a first thermoelectric device 52 and a second thermoelectric device 52 in thermal communication with second thermal conductor 106 and energy storage device 54. Energy storage device 54 is in conductive thermal communication with second thermal conductor 106. Although embodiments depicted in FIGS. 4-7 disclose a single thermoelectric device 52, and the embodiment in FIG. 8 depicts use of a first thermoelectric device 52 and a second thermoelectric device 52, it will be appreciated that any number of thermoelectric devices 52 may be used in any given embodiment of this disclosure. Power supply 110 is not illustrated in FIG. 8 for sake of clarity. Thus, electrical lead lines illustrated extending from both first thermoelectric device 52 and second thermoelectric device 52 are understood to be connected to power supply 110 prior to operation of powered thermal exchange system 50. First thermal conductor 102 depicted in FIG. 8 is in the form of a flexible thermal conductor that extends over both of first thermoelectric device 52 and second thermoelectric device 52. In one form, first thermal conductor 102 is made of a graphitic material. In one embodiment, first thermal conductor 102 is in the form of a graphene ribbon. Use of a graphene ribbon provides thermal conductivity with first thermoelectric device 52 and second thermoelectric device 52, thus also providing heat transfer between first thermoelectric device 52 and second thermoelectric device 52 with local environment 58 of the graphene ribbon. As mentioned herein, graphene ribbon (or any other graphitic material) may have a higher thermal conductivity than other material types, thus providing more compact thermal exchange system 50. Any size, number, and density of graphene ribbon is contemplated for use. For example, two graphene ribbons may be used, one for each of first thermoelectric device 52 and second thermoelectric device 52. Such use of two graphene ribbons in lieu of one graphene ribbon may reduce cost if an intermediate space between first thermoelectric device 52 and second thermoelectric device 52 is not required for heat transfer purposes to include an amount of graphene ribbon. Furthermore, the graphene ribbon may be pulled taut between its ends, it may be folded upon itself, or it may be bunched up. Any suitable configuration for any given application is contemplated. The graphene ribbon may be laminated with a structural member to improve rigidity and robustness, thus forming a composite construction that includes a graphene ribbon layer.

Powered thermal exchange system 50 may include a fan 116 to improve heat transfer between first thermal conductor 102 and local environment 58 by moving a cooling medium (e.g., air) over first thermal conductor 102 (e.g., improving convective heat transfer). Fan 116 may be any size and shape, and configured to move the cooling medium over first thermal conductor 102. In some embodiments, fan 116 may take the form of a liquid pump structured to pass cooling medium in the form of a liquid. Moving the cooling medium over first thermal conductor 102 may reduce energy required to operate power supply 110 when powered thermal exchange system 50 is in a mode of operation that requires electrical energy, or may increase generation of electrical energy when powered thermal exchange system 50 is in a mode of operation that generates electrical power. Fan 116 may be powered by energy storage device 54 in some embodiments, or may be powered by an external source such as that discussed above with respect to thermoelectric device 52. Additionally fan 116 may be positioned to push air towards first thermal conductor 102 or positioned to draw air away from first thermal conductor 102. The direction of air flow produced from fan 116 may be oriented in the same direction as a direction of travel of a vehicle to which the fan 116 is connected. As will be appreciated, heat transfer may occur through convection when circulating cooling medium via fan 116.

FIG. 8 depicts energy storage device 54 having several cells 109a-109h that together provide electrical power and/or receive electrical power. Cells 109a-109h are depicted as arranged in a single row in which each cell is elongate in shape with a first end 120 in conductive thermal communication with second thermal conductor 106, but other arrangements are also contemplated. Furthermore, cell 109d and cell 109e in the illustrated embodiment are located on the other side of second thermal conductor 106 from first thermoelectric device 52 and second thermoelectric device 104, and specifically in a gap formed between first thermoelectric device 52 and second thermoelectric device 104. Still further, a portion of cell 109h extends past an end of second thermoelectric device 52. It is therefore contemplated that at least one or more portions of energy storage device 54 need not align precisely on one side of second thermal conductor 106 with thermoelectric device 52. In other embodiments, all of energy storage device 54 may be aligned to overlap with each thermoelectric device 52 located opposite energy storage device 54. Some forms of thermoelectric device 52 may be expensive but also may sufficiently cool a larger body of batteries if paired with a conducting plate. Furthermore, distributing multiple devices over a conducting plate in the manner described above may provide more thermal uniformity than a single centralized device, etc.

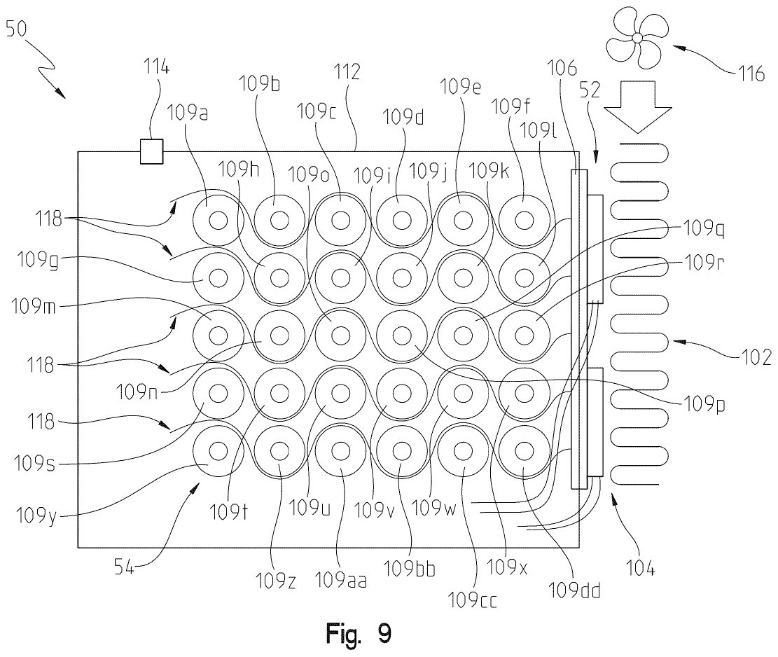

FIG. 9 depicts an embodiment of powered thermal exchange system 50 at least partially enclosed in a housing 112, where such housing may be mounted to, for example, a vehicle. As illustrated, housing 112 encloses energy storage device 54 and at least part of second thermal conductor 106, where another part of second thermal conductor 106, thermoelectric device 52, and first thermal conductor 102 are located external to housing 112. Housing 112 may be used to protect energy storage device 54 from external debris, protect energy storage device 54 from contact with harmful objects, and/or provide for an enclosed environment to protect personnel such as operators of a vehicle. Housing 112 may provide a hermetic seal to enclose energy storage device 54. In the illustrated embodiment, housing 112 includes a vent 114 that may include a closed position and an open position. The closed position may be utilized when maintaining a hermetic seal of the housing 112. The open position may be used to allow venting of gas or other fluids in the case of discharge of same from energy storage device 54. Vent 114, therefore, may act as a safety mechanism in furtherance of protecting an operator of a vehicle. Vent 114 may take a variety of forms, including a pressure relief valve that is spring biased to the closed position but that may be opened if pressure within housing 112 rises above a threshold during an over-pressure condition of the interior of the sealed housing. Enclosing energy storage device 54 within housing 112 may limit the ability to effectively transfer heat to/from energy storage device 54. For example, housing 112 may limit the ability of energy storage device 54 to be convectively cooled by a fluid (e.g., air or water) and/or conductively cooled through a wall of housing 112. In such situations, T2 may exceed either of maximum operating temperature 86 or minimum operating temperature 66. Use of thermal exchange system 50 can aid in lowering or raising T2 of energy storage device 54 within either of maximum operating temperature 86 or minimum operating temperature 66 as described herein.

As illustrated, second thermal conductor 106 is positioned through a wall of housing 112 and serves to transfer heat between energy storage device 54 and thermoelectric device 52. In some embodiments, second thermal conductor 106 may be integrally formed in the wall of housing 112. In other embodiments, second thermal conductor 106 may be inserted into an aperture of the wall of housing 112.

FIG. 9 depicts a first thermoelectric device 52 and a second thermoelectric device 104 in thermal communication with second thermal conductor 106 and energy storage device 54. Energy storage device 54 is in conductive thermal communication with second thermal conductor 106. Although embodiments depicted in FIGS. 4-7 disclose a single thermoelectric device 52, and the embodiment in FIG. 9 depicts use of a first thermoelectric device 52 and a second thermoelectric device 104, it will be appreciated that any number of thermoelectric devices 52 may be used in any given embodiment of this disclosure. Power supply 110 is not illustrated in FIG. 9 for sake of clarity. Thus, electrical lead lines illustrated extending from both first thermoelectric device 52 and second thermoelectric device 104 are understood to be connected to power supply 110 prior to operation of powered thermal exchange system 50. In one form, first thermal conductor 102 and second thermal conductor 118 are made of a graphitic material. Heat sinks of varying materials may be substituted. In one embodiment, first thermal conductor 102 and second thermal conductor 118 are in the form of a graphene ribbon. First thermal conductor 102 depicted in FIG. 9 is in the form of a flexible thermal conductor that extends over both of first thermoelectric device 52 and second thermoelectric device 104. In one form, second thermal conductor 118 is in the form of a flexible thermal conductor capable of being wrapped, bent, folded, etc. around or within energy storage device 54, and specifically between cells of energy storage device 54. Furthermore, the graphene ribbon may be pulled taut between its ends, be loose, or be bunched up. Any suitable configuration for any given application is contemplated. Any size, number, and density of graphene ribbon is contemplated for use. Each row of cells includes a separate thermal conductor 118 interwoven between neighboring cells of the row of cells. For example, two graphene ribbons may be used, one for each of first thermoelectric device 52 and second thermoelectric device 104. The graphene ribbon may be laminated with a structural member to improve rigidity and robustness, thus forming a composite construction that includes a graphene ribbon layer.

Powered thermal exchange system 50 may include a fan 116 to improve heat transfer between first thermal conductor 102 and local environment 58 by moving a cooling medium (e.g., air) over first thermal conductor 102. Fan 116 may be any size and shape, and configured to provide energy to move the cooling medium over first thermal conductor 102. In some embodiments, fan 116 may take the form of a liquid pump structured to pass cooling medium in the form of a liquid. Improving heat transfer may reduce energy required to operate power supply 110 when powered thermal exchange system 50 is in a mode of operation that requires electrical energy, or may improve generation of electrical energy when powered thermal exchange system 50 is in a mode of operation that generates electrical power. Fan 116 may be powered by energy storage device 54 in some embodiments, or may be powered by an external source such as that discussed above with respect to thermoelectric device 52. Additionally fan 116 may be positioned to push air towards first thermal conductor 102 or positioned to draw air away from first thermal conductor 102.

FIG. 9 depicts energy storage device 54 having several cells 109a-109dd that together provide electrical power and/or receive electrical power. Cells 109a-109dd are depicted as arranged in several parallel rows and in which each row includes a cell closest to second thermal conductor 106 (e.g., cell 109f, cell 1091, cell 109q, cell 109w, and cell 109dd) and a cell furthest from second thermal conductor 106 (e.g., cell 109a, cell 109g, cell 109m, cell 109s, and cell 109y)), but other arrangements are also contemplated. Furthermore, a row of cells 109m-109r are located on a side of second thermal conductor 106 opposite from first thermoelectric device 52 and second thermoelectric device 52, and specifically in a gap formed between first thermoelectric device 52 and second thermoelectric device 104. It is contemplated that at least one or more portions of energy storage device 54 need not align precisely on one side of second thermal conductor 106 with thermoelectric device 52. In other embodiments, all of energy storage device 54 may be aligned to overlap with each thermoelectric device 52 located opposite energy storage device 54.

FIG. 9 also depicts use of second thermal conductor 118 in conductive thermal communication with first thermal conductor 102. Given the arrangement of the cells of energy storage device 54, energy storage device 54 is in conductive thermal communication with second thermal conductor 118 which in turn is in thermal communication with first thermal conductor 102 via thermoelectric devices 52. In this manner, second thermal conductor 118 aids heat transfer from within energy storage device 52 and to first thermal conductor 102 relative to an embodiment that lacks second thermal conductor 118. In particular, an embodiment that lacks second thermal conductor 118 may rely upon convective heat transfer in lieu of conductive heat transfer to transfer heat between the cells of energy storage device 54 and thermal conductor 106. Second thermal conductor 118 is a flexible thermal conductor woven between cells of energy storage device 54 and used to aid in conveyance of heat to or from cells 109a-109dd. In the illustrated embodiment, thermal conductor 118 is routed between alternating sides of adjacent cells of cells 109a-109dd so as to form an interwoven configuration. Such a configuration may aid in improving heat transfer between cells 109a-109dd relative to a configuration that either lacks thermal conductor 118 or includes a thermal conductor located on a single side of a row of cells. In some embodiments, second thermal conductor 118 may be laid to one side of a row of cells, such as one side of cells 109a-109f. For example, instead of interweaving thermal conductor 118 between adjacent cells within a row of cells (e.g., cells 109a-109f), thermal conductor 118 may be laid to one side of the row, with another thermal conductor 118 laid to one side of an adjacent row of cells (e.g., cells 109g-109l). In this manner, several thermal conductor 118 may be laid to one side of a row of cells and along one or more of the plurality of cells in energy storage device 54. In some embodiments, a single thermal conductor 118 may be shared between adjacent rows of cells. In any of the embodiments, second thermal conductor 118 may extend lengthwise along each cell (e.g., from a top 111 of a cell (FIG. 8) to a bottom 113 of a cell (FIG. 8)) for the entirety of the length of each cell. In other embodiments, thermal conductor 118 may extend only partially along the length of the cells. Cost of materials may dictate whether the second thermal conductor 118 extends fully or only partially along the length of the cells. Some embodiments of energy storage device 54 may have a variety of different configurations of second thermal conductor 118.

FIG. 10 depicts an electrical and thermal schematic of one form of powered thermal exchange system 50 integrated with a vehicle that includes a vehicle powertrain 122 useful to provide motive power from a prime mover of the vehicle to a propulsor of the vehicle (e.g., ground engaging members such as wheels, tracks, etc.). In the illustrated embodiment, vehicle powertrain 122 receives electrical power from a power bus 124 to drive the prime mover of the vehicle. Power supply 110, depicted in one form in FIG. 10 as a power converter, receives and/or contributes electrical power to power bus 124 (e.g., in some embodiments, power supply 110 is structured to provide bi-directional power with the thermoelectric device 54 via power bus 124). Power supply 110 is also, in keeping with various other embodiments herein, in power communication with thermoelectric device 52. Power supply receives and/or contributes electrical power to thermoelectric device 52. Power supply 110 is controlled via a power controller 126 to regulate the amount of power communicated between thermoelectric device 52 and power bus 124. In modes of operation where thermoelectric device 52 requires power (e.g., FIG. 4 and FIG. 5), power supply 110 receives electrical power from power bus 124 and delivers the electrical power to thermoelectric device 52. In modes of operation where thermoelectric device 52 generates power (e.g., FIG. 6 and FIG. 7), power supply 110 receives electrical power from thermoelectric device 52 and delivers the electrical power to power bus 124 (in some cases electrical power is then routed from power bus 124 to energy storage device 54. Power controller 126 may also regulate electrical power delivered to fan 116 from power supply 110. In some embodiments, power may be delivered to fan 116 continuously.

Vehicle powertrain 122 is configured to receive power from power bus 124, such as from energy storage device 54 and/or a charger 128. Charger 128 may be an external charger that receives electrical power from a power source, such as but not limited to a grid (e.g., 110V and/or 220V available in residential homes and commercial establishments) and/or may include an energy storage device similar to embodiments of energy storage device 54. Charger 128 may be coupled to power bus 124 via a port 130. Port 130 may take any form suitable to receive an input from charger 128.

In some embodiments, energy storage device 54 may be charged from power bus 124 which receives power from charger 128 though port 130. During a charging operation, energy storage device 54 may receive a sufficiently high electrical load that increased heating results. Power controller 126 may control cooling of energy storage device 54 via thermoelectric device 52. For example, in some embodiments, power controller 126 may sense that a temperature of energy storage device 54 is above or approaching a maximum threshold, at which point power controller 126 may control thermoelectric device 52 to transfer heat away from energy storage device 54 and to first thermal conductor 102 via second thermal conductor 106 and thermoelectric device 52. Power controller 126 may also control thermoelectric device 52 to heat energy storage device 54, or alternatively generate power consistent with other modes of operation described herein.

Powered thermal exchange system 50 also includes a sensor 115 configured to generate a signal 117 having data indicative of a temperature on, in, or in proximity to energy storage device 54 (e.g., temperature T2 in FIGS. 4-7). A temperature in proximity to energy storage device 54 may be a temperature at a location representative of energy storage system 54 but nevertheless not in or on energy storage system 54 (e.g., a temperature a location which is calibrated to be representative of energy storage system 54 in that a temperature at that location is considered a sufficient proxy for purposes of maintaining temperature of energy storage system 54 relative to a minimum operating temperature and a maximum temperature such as minimum operating temperature 66 in FIGS. 3A-3B and/or a maximum operating temperature 86 of FIGS. 3A-3B). Power controller 126 is in data communication with sensor 115 and is configured to receive signal 117 having data indicative of temperature of energy storage device 54 (e.g., temperature on, in, or in proximity to energy storage device 54) and control operation of power converter 110 based on the data indicative of temperature of energy storage device 54. In some embodiments, power converter 110 may also include one or more switches useful to reconfigure a direction of power flow and/or an amount of power flow to/from thermoelectric device 52 using control signals from power controller 126 based on data indicative of temperature of energy storge device 54. In some embodiments, powered thermal exchange system 50 may also include a sensor 119 configured to generate a signal 121 having data indicative of a temperature of local environment 58 (e.g., temperature T1 in FIGS. 4-7). Power controller 126 is in data communication with sensor 119 and is configured to receive signal 121 having data indicative of temperature of local environment 58 and control operation of power converter 110 based on the data indicative of temperature of local environment 58. In some embodiments, power converter 110 may include one or more switches useful to reconfigure a direction of power flow and/or an amount of power flow to/from thermoelectric device 52 using control signals from power controller 126 based on data indicative of temperature of energy storge device 54.

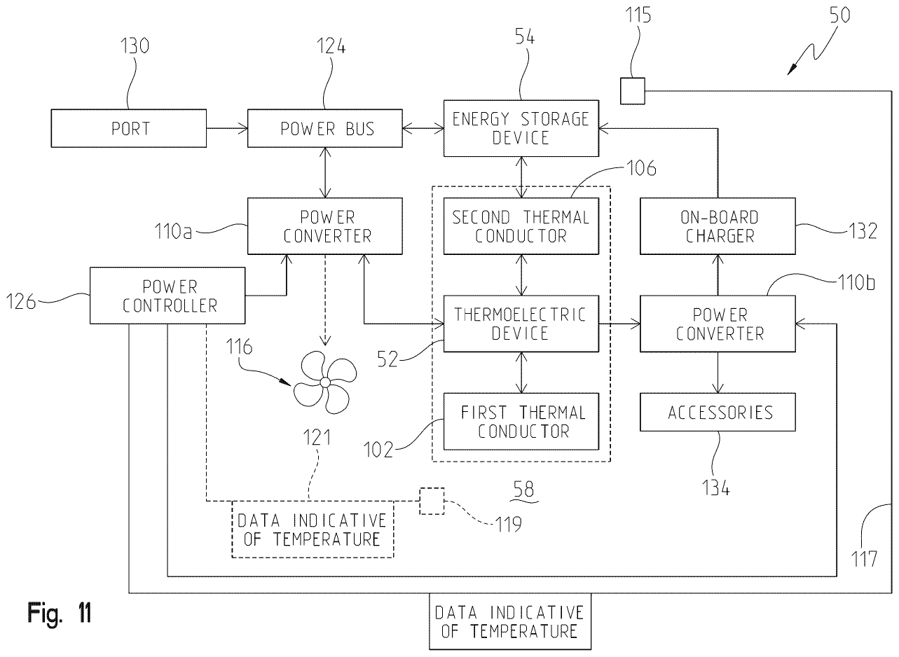

FIG. 11 depicts another embodiment of an electrical and thermal schematic of another form of powered thermal exchange system 50 integrated with a vehicle in which the vehicle is not connected to charger 128. A charger 128 may be connected through port 130. Though not depicted, power bus 124 is capable of delivering electrical power to a powertrain similar to vehicle powertrain 122. The electrical and thermal schematic of FIG. 11 depicts an operational configuration of the vehicle away from charger 128 in which power controller 126 may monitor temperature of energy storage device 54 and regulate operation of thermoelectric device 52 based on temperature of energy storage device 54. FIG. 11 includes a first power supply 110a and a second power supply 110b, each responsible for performing separate functions and each depicted in one form in FIG. 11 as power converters. For example, in some embodiments first power supply 110a may provide power to a powertrain of a vehicle (not depicted here but, e.g., vehicle powertrain 122 of FIG. 10), and second power supply 110b may be used to provide power to energy storage device 54 and/or other non-powertrain related accessories. In some embodiments, power supply 110a and power supply 110b are combined in a single power supply 110. First power supply 110a may communicate electrical power between power bus 124 and thermoelectric device 52, as described herein. Second power supply 110b is configured to provide electrical power to energy storage device 54 via an on-board charger 132, and, in some embodiments, to also to supply electrical power to accessories 134. Accessories may include any device on board the vehicle that consume electrical power and that are not involved in providing power to the power train, such as, but not limited to, a radio, speakers, horn, turn blinker, headlamp, brake light, etc. As in the depiction of FIG. 10, power controller 126 may control first power supply 110a to regulate operation of thermoelectric device 52, to either cool or heat energy storage device 54, or to generate power as a result of operation of thermoelectric device 52.

Powered thermal exchange system 50 also includes a sensor 115 configured to generate a signal 117 having data indicative of a temperature on, in, or in proximity to energy storage device 54 (e.g., temperature T2 in FIGS. 4-7), where a temperature in proximity to energy storage device 54 may be a distance taken at a location representative of energy storage system 54 (e.g., a location which is calibrated to be representative of energy storage system 54 in that a temperature at that location is considered a sufficient proxy for maintaining temperature of energy storage system 54 relative to a minimum operating temperature and a maximum temperature such as minimum operating temperature 66 in FIGS. 3A-3B and/or a maximum operating temperature 86 of FIGS. 3A-3B). Power controller 126 is in data communication with sensor 115 and is configured to receive signal 117 having data indicative of temperature of energy storage device 54 (e.g., temperature on, in, or in proximity to energy storage device 54) and control operation of power converter 110a and/or power converter 110b based on the data indicative of temperature of energy storage device 54. In some embodiments, power converter 110a and/or power converter 110b may also include one or more switches useful to reconfigure a direction of power flow and/or an amount of power flow to/from thermoelectric device 52 using control signals from power controller 126 based on data indicative of temperature of energy storge device 54. In some embodiments, powered thermal exchange system 50 may also include a sensor 119 configured to generate a signal 121 having data indicative of a temperature of local environment 58 (e.g., temperature T1 in FIGS. 4-7). Power controller 126 is in data communication with sensor 119 and is configured to receive signal 121 having data indicative of temperature of local environment 58 and control operation of power converter 110a and/or power converter 110b based on the data indicative of temperature of local environment 58. In some embodiments, power converter 110a and/or power converter 110b may include one or more switches useful to reconfigure a direction of power flow and/or an amount of power flow to/from thermoelectric device 52 using control signals from power controller 126 based on data indicative of temperature of energy storge device 54.

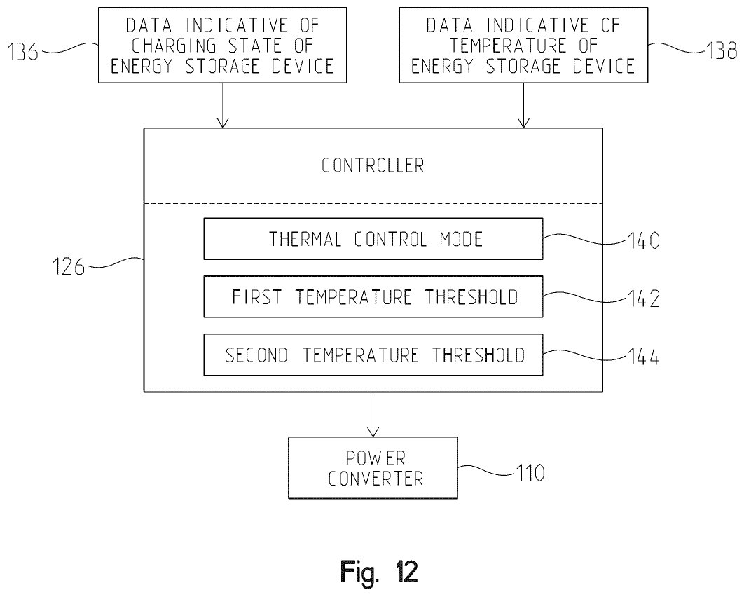

FIG. 12 depicts an embodiment of power controller 126 configured to receive, at block 136, data indicative of a charging state of energy storage device 54, and to also receive, at block 138, data indicative of temperature of energy storage device 54. Data may be a monitored including voltage level, a monitored current level, a monitored resistance, a digital signal such as a packet formatted according to a network protocol, or other suitable types of electrical information (e.g., sensor 115 may represent a suite of sensors including a temperature sensor and any of the aforementioned sensors; in some embodiments, sensor 115 configured to generate a signal 117 having data indicative of a temperature on, in, or in proximity to energy storage device 54, the temperature of other devices in powered thermal exchange system 50 and/or a vehicle having powered thermal exchange system 50, an operator compartment temperature of a vehicle having powered thermal exchange system 50, and/or an external ambient temperature such as temperature of local environment 58). Power controller 126 is configured to regulate power supply 110a based upon data at block 136 and block 138. Specifically, power controller 136 is configured to evaluate data at block 136 to determine a thermal control mode 140 in which power controller 136 evaluates and compares data at block 138 to a first temperature threshold 142 and a second temperature threshold 144. In one embodiment, first temperature threshold 142 is the minimum temperature threshold discussed herein and second temperature threshold 144 is the maximum temperature threshold discussed herein. Thus, if power controller 126 determines based on the data from block 138 that the temperature of energy storage device 54 is below first temperature threshold 142, powered thermal exchange system 50 may be operated to provide heating to energy storage device 54. If power controller 126 determines based on the data from block 138 that the temperature of energy storage device 54 is above second temperature threshold 144, powered thermal exchange system 50 may be operated to provide cooling to energy storage device 54. If power controller 126 determines based on the data from that block 138 that the temperature of energy storage device 54 is above first temperature threshold 142 and below second temperature threshold 144, powered thermal exchange system 50 may be operated to generate power from thermoelectric device 52 and provide the generated power to power supply 110. In some embodiments, such as in FIG. 11, power supply 110 may take the form of power supply 110a and power supply 110b such as is depicted in FIG. 11.

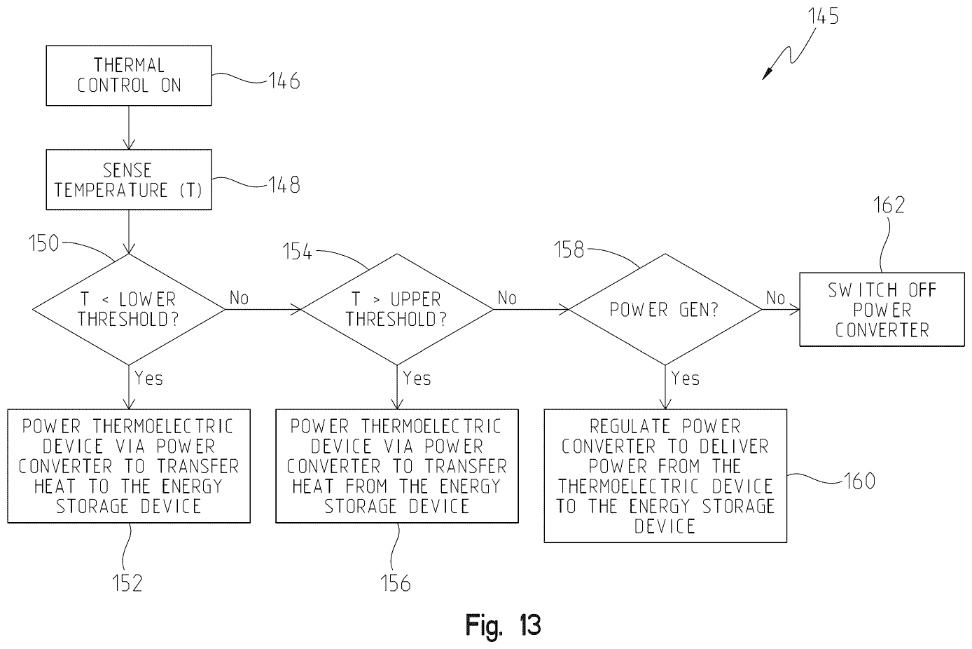

Turning now to FIG. 13, a flow diagram 145 is illustrated depicting operation of powered thermal exchange system 50 through use of power controller 126. Reference will be made to powered thermal exchange system 50 depicted in FIG. 10, and specifically to power converter 110, but it will be appreciated that the flow diagram 145 depicted in FIG. 13 may also be used with the powered thermal exchange system 50 depicted in FIG. 11, and specifically to power converter 110a and power converter 110b. Still further, the flow diagram 145 is also applicable to power thermal exchange system 50 depicted in any of FIGS. 4-9. Flow diagram 145 begins at block 146 which indicates that power controller 126 has been commanded to place thermal control in the ON condition. Power controller 126 may be commanded to place thermal control in the ON condition through a user selection (e.g., physical switch such as a button or selector, or virtual through wireless command) or automatically as part of a vehicle start routine. Once in the ON condition, power controller 126 will sense temperature of storage device 54 at block 148. The temperature may be sensed (e.g., through sensor 115) by any suitable temperature sensing device such as a thermocouple, temperature switch, etc. used to sense temperature of, in, or near energy storage device 54. The sensed temperature may be provided to power controller 126 though physical cabling or wireless communication. Upon receipt and potential processing of temperature provided at block 148, power controller 126 will determine at decision block 150 whether the sensed temperature from block 148 is above a lower threshold. The lower threshold referred to in decision block 150 may be the minimum temperature threshold mentioned herein (e.g., first temperature threshold 142). If sensed temperature from block 148 is determined to be lower than the lower threshold at decision block 150, power controller 126 will command power supply 110 as a result of execution of block 152 to provide power to thermoelectric device 52 to transfer heat to energy storage device 54. Such a result corresponds to FIG. 4 described above. If, however, sensed temperature from block 148 is determined to not be lower than lower threshold, power controller 126 moves to decision block 154 to determine whether the sensed temperature from block 148 is below an upper threshold. The upper threshold referred to in decision block 154 may be the maximum temperature threshold mentioned herein (e.g., second temperature threshold 144). If sensed temperature from block 148 is determined to be higher than the upper threshold at decision block 154, power controller 126 will command power supply 110a as a result of execution of block 156 to provide power to thermoelectric device 52 to transfer heat from energy storage device 54. Such a result corresponds to FIG. 5 described above. If, however, sensed temperature from block 148 is determined to not be higher than upper threshold, power controller 126 moves to decision block 158 to determine powered thermal exchange system 50 should be operated in a power generation mode. The determination of whether to operate in power generation mode may be dependent upon a user selection. For example, power controller 126 may issue an advisory to an operator that power generation mode is available given that sensed temperature from block 148 is above the lower threshold and below the upper threshold. In such a situation, the operator may be given a choice to activate power generation mode at decision block 158. To set forth another example, a user may configure powered thermal exchange system 50, and specifically power controller 126, to default to power generation mode if decision block 150 and decision block 154 both result in arriving at decision block 158. Alternatively, a user may also configure powered thermal exchange system 50, and specifically power controller 126, to default to power generation mode if sensed temperature from block 148 is within a temperature range above the lower threshold and below the upper threshold. Whether the determination of power generation at decision block 158 is made by operator selection, is automatic based on temperatures, or is automatic based on an operator selection of a suitable temperature range for power generation, if decision block 158 results in selection of a power generation mode, power controller 126 may execute block 160 to operate powered thermal exchange system 50 such that power from thermoelectric device 52 is delivered to energy storage device 54 (e.g., through power converter 110 and power bus 124 in FIG. 10). If, in contrast, decision block 158 results in a determination that power generation mode is not to be used, power controller 126 may execute block 162 to configure power supply 110 in an OFF condition. It will be appreciated that the flow diagram 145 depicted in FIG. 13 may be repeated. In some embodiments in which power controller 126 is an analog controller, flow diagram 145 may be repeated continuously. In some embodiments in which power controller 126 is digital, flow diagram 145 may be repeated at any given execution rate.

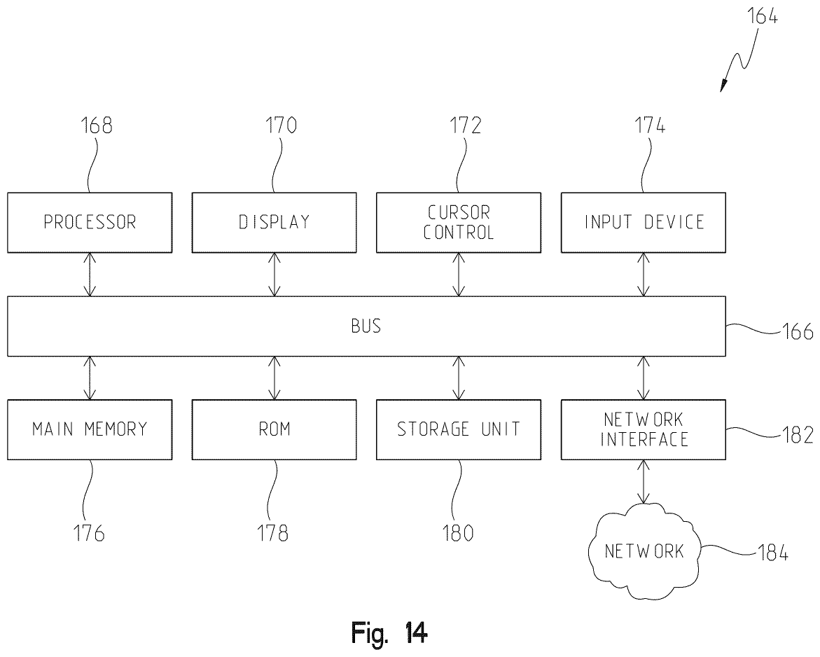

FIG. 14 illustrates a diagram of a computing system 164 for implementing one or more aspects of powered thermal exchange system 50 including the execution of flow diagram 145 by power controller 126, in accordance with certain embodiments of the present disclosure. For example, some or all of the functions of power controller 126 may be performed by a computing system that has similar components as computing system 164. This diagram is merely an example, which should not unduly limit the scope of the claims. One of ordinary skill in the art would recognize many variations, alternatives, and modifications.

The computing system 164 includes a bus 166 or other communication mechanism for communicating information between a processor 168, a display 170, a cursor control component 172 (e.g. a pointer control for display 170), an input device 174, a main memory 176, a read only memory (ROM) 178, a storage unit 180, and/or a network interface 182. In some examples, bus 166 is coupled to processor 168, display 170, cursor control component 172, input device 174, main memory 176, read only memory (ROM) 214, storage unit 180, and/or network interface 182. And, in certain examples, network interface 182 is coupled to a network 184.

In some examples, processor 168 includes one or more general purpose microprocessors. In some examples, main memory 176 (e.g., random access memory (RAM), cache and/or other dynamic storage devices) is configured to store information and instructions to be executed by processor 168. In certain examples, main memory 176 is configured to store temporary variables or other intermediate information during execution of instructions to be executed by processor 168. For example, the instructions, when stored in storage unit 180 accessible to processor 168, render computing system 164 into a special-purpose machine that is customized to perform the operations specified in the instructions. In some examples, ROM 178 is configured to store static information and instructions for processor 168. In certain examples, storage unit 180 (e.g., a magnetic disk, optical disk, or flash drive) is configured to store information and instructions.

Thus, computing system 164 may include at least some form of computer readable media. The computer readable media may be any available media that may be accessed by processor 168 or other devices. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may not include communication media.

In some embodiments, display 170 (e.g., a cathode ray tube (CRT), an LCD display, or a touch screen) is configured to display information to a user of computing system 164. In some examples, input device 174 (e.g., alphanumeric and other keys) is configured to communicate information and commands to processor 168. For example, cursor control 172 (e.g., a directional pad, a trackball, or cursor direction keys) is configured to communicate additional information and commands (e.g., to control cursor movements on display 170) to processor 168.

FIGS. 15 and 16 illustrate an outdoor recreational vehicle 186 and an outdoor recreational vehicles 188 each having vehicle powertrain 122 powered by energy storage device 54 and including powered thermal exchange system 50. Though not illustrated, other components of powered thermal exchange system 50, as well as other components illustrated elsewhere such as in FIGS. 10, 11, 12, and 14, may also be incorporated with outdoor recreational vehicle 186 and outdoor recreational vehicle 188. For example, outdoor recreational vehicle 186 and/or outdoor recreational vehicle 188 may include power bus 124, first power supply 110a, second power supply 110b, power controller 126, and accessories 134, among potential others. In some embodiments of recreational vehicles having powered thermal exchange system 50, first thermal conductor 102 can be a radiator that exchanges heat with local environment 58. For example, first thermal conductor 102 can be positioned to receive a flow of air as a result of the recreational vehicle being in motion. A flow of air across first thermal conductor 102 can be a result solely of motion of the recreational vehicle and/or may also be caused by fan 116. Additional details of an example outdoor recreational vehicle are provided in U.S. patent application Ser. No. 17/702,050, filed Mar. 23, 2022, published as U.S. Published Application No. US20220306222A1, the entire disclosure of which is expressly incorporated by reference herein. Use of energy storage device 54 including powered thermal exchange system 50 enables thermoelectric cooling during fast charging (e.g., L3+_charging) in vehicles that have aggressive size constraints such as motorcycles, to set forth just one example.

It will be appreciated that the figures illustrated above are merely examples, which should not unduly limit the scope of the claims. One of ordinary skill in the art would recognize many variations, alternatives, and modifications.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The following clauses illustrate example subject matter described herein.

Clause 1: A powered thermal exchange system, comprising: an energy storage device; a first thermal conductor in thermal communication with the energy storage device; and a thermoelectric device positioned between the energy storage device and the first thermal conductor, the thermoelectric device in conductive thermal communication with the energy storage device and the first thermal conductor, the thermoelectric device configured to receive an electrical power from a power supply and generate a thermal gradient through the thermoelectric device to transfer a thermodynamic heat between the energy storage device and the first thermal conductor.

Clause 2: The powered thermal exchange system of clause 1, further comprising a second thermal conductor in conductive thermal communication with the energy storage device, wherein the thermoelectric device is positioned in conductive thermal communication with the second thermal conductor and the first thermal conductor.

Clause 3: The powered thermal exchange system of clause 2, wherein the thermoelectric device in conductive thermal communication with the energy storage device via the second thermal conductor.

Clause 4: The powered thermal exchange system of any one of clauses 2 and 3, wherein the second thermal conductor includes a graphitic material.

Clause 5: The powered thermal exchange system of clause 4, wherein the graphitic material is graphene.

Clause 6: The powered thermal exchange system of any one of clauses 4 and 5, wherein the second thermal conductor includes at least one ribbon of the graphitic material.

Clause 7: The powered thermal exchange system of clause 6, wherein the energy storage device includes a plurality of cells and the at least one ribbon is positioned between the plurality of cells.

Clause 8: The powered thermal exchange system as in any preceding clause, wherein the first thermal conductor includes a graphitic material.

Clause 9: The powered thermal exchange system of clause 8, wherein the graphitic material is graphene.

Clause 10: The powered thermal exchange system as in any preceding clause, wherein the power supply is configured to receive power from one of an external power source and the energy storage device.

Clause 11: The powered thermal exchange system as in any preceding clause, wherein the energy storage device is operatively coupled to the thermoelectric device to transmit the electrical power between the thermoelectric device and the energy storage device.

Clause 12: The powered thermal exchange system of clause 11,wherein the power supply is operatively coupled between the thermoelectric device and the energy storage device.

Clause 13: The powered thermal exchange system of clause 12, wherein the power supply is structured to provide bi-directional power with the thermoelectric device.

Clause 14: The powered thermal exchange system of any of clauses 12 and 13, wherein the power supply provides power to the energy storage device through a power bus.

Clause 15: The powered thermal exchange system of clause 14, wherein the power supply is a DC/DC converter, and wherein the power supply is coupled between the thermoelectric device and the power bus, wherein the power bus is electrically coupled between the energy storage device and the DC/DC converter.

Clause 16: The powered thermal exchange system as in any preceding clause, further comprising a power controller configured to regulate operation of the power supply.

Clause 17: The powered thermal exchange system of clause 16, wherein the power controller is configured to operate the power supply based on data indicative of a temperature of the energy storage device.

Clause 18: The powered thermal exchange system as in any preceding clause, wherein the thermoelectric device includes a mode of operation in which the thermodynamic heat is thermoelectrically transferred from the first thermal conductor to the energy storage device.

Clause 19: The powered thermal exchange system as in any preceding clause, wherein the thermoelectric device includes a mode of operation in which the thermodynamic heat is thermoelectrically transferred from the energy storage device to the first thermal conductor.

Clause 20: The powered thermal exchange system as in any preceding clause, wherein in one mode of operation the thermoelectric device is configured to generate an electrical power as a result of the thermal gradient through the thermoelectric device between the energy storage device and the first thermal conductor.

Clause 21: A powered thermal exchange system, comprising: an energy storage device configured to transmit electrical power; a sealed housing configured to enclose the energy storage device disposed in an interior volume of the sealed housing, the sealed housing structured to prevent transfer of fluid between the interior volume of the sealed housing and an exterior of the sealed housing; and a thermoelectric device in conductive thermal communication with the energy storage device, the thermoelectric device structured to transfer heat between the energy storage device and the exterior of the sealed housing.

Clause 22: The powered thermal exchange system of clause 21, wherein the sealed housing is coupled with a pressure vent configured to discharge, during an over-pressure condition of the interior volume of the sealed housing, a fluid from within the interior volume of the sealed housing to the exterior of the sealed housing.

Clause 23: The powered thermal exchange system of clause 22, wherein the pressure vent is a check valve.

Clause 24: The powered thermal exchange system of clause 22, further comprising a first thermal conductor in conductive thermal communication with the exterior of the sealed housing and the thermoelectric device and a second thermal conductor in conductive thermal communication with the energy storage device and the thermoelectric device.

Clause 25: The powered thermal exchange system of clause 24, wherein the second thermal conductor includes a graphitic material.

Clause 26: The powered thermal exchange system of clause 25, wherein the graphitic material is graphene.

Clause 27: The powered thermal exchange system of any one of clauses 25 and 26, wherein the second thermal conductor includes at least one ribbon of the graphitic material.

Clause 28: The powered thermal exchange system of clause 27, wherein the energy storage device includes a plurality of cells and the at least one ribbon is positioned between the plurality of cells.

Clause 29: The powered thermal exchange system of any one of clauses 24-28, wherein the first thermal conductor includes a graphitic material.

Clause 30: The powered thermal exchange system of clause 29, wherein the graphitic material is graphene.

Clause 31: A method for thermoelectrically transferring heat, the method comprising: providing electric power to a thermoelectric device; transferring heat in a first mode of operation from an energy storage device through a wall of a sealed housing to a first thermal conductor as a result of a thermal gradient formed by the providing electric power to the thermoelectric device; and removing the transferred heat from the first thermal conductor.

Clause 32: The method of clause 31, wherein the transferring includes conductively transferring the heat between the energy storage device and the first thermal conductor via the thermoelectric device.

Clause 33: The method of clause 32, further comprising conductively transferring the heat between the energy storge device and the thermoelectric device via a second thermal conductor.

Clause 34: The method of clause 33, wherein conductively transferring the heat between the energy storge device and the thermoelectric device via a second thermal conductor includes the step of transferring heat through a graphitic material.

Clause 35: The method of clause 34, wherein the graphitic material includes graphene.

Clause 36: The method of clause 34, wherein transferring the heat through a graphitic material includes transferring heat through a graphene ribbon positioned adjacent at least one cell of the energy storage device.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A powered thermal exchange system, comprising:
an energy storage device;
a first thermal conductor in thermal communication with the energy storage device; and
a thermoelectric device positioned between the energy storage device and the first thermal conductor, the thermoelectric device in conductive thermal communication with the energy storage device and the first thermal conductor, the thermoelectric device configured to receive an electrical power from a power supply and generate a thermal gradient through the thermoelectric device to transfer a thermodynamic heat between the energy storage device and the first thermal conductor.

2. The powered thermal exchange system of claim 1, further comprising a second thermal conductor in conductive thermal communication with the energy storage device, wherein the thermoelectric device is positioned in conductive thermal communication with the second thermal conductor and the first thermal conductor.

3. The powered thermal exchange system of claim 2, wherein the thermoelectric device is in conductive thermal communication with the energy storage device via the second thermal conductor.

4. The powered thermal exchange system of claim 2, wherein the second thermal conductor includes at least one ribbon of a graphitic material.

5. The powered thermal exchange system of claim 4, wherein the energy storage device includes a plurality of cells and the at least one ribbon is positioned between the plurality of cells.

6. The powered thermal exchange system of claim 1, wherein the first thermal conductor includes a graphitic material.

7. The powered thermal exchange system of claim 1, wherein the power supply is configured to receive power from one of an external power source and the energy storage device.

8. The powered thermal exchange system of claim 1, wherein the energy storage device is operatively coupled to the thermoelectric device to transmit the electrical power between the thermoelectric device and the energy storage device.

9. The powered thermal exchange system of claim 8, wherein the power supply is operatively coupled between the thermoelectric device and the energy storage device.

10. The powered thermal exchange system of claim 9, wherein the power supply is structured to provide bi-directional power with the thermoelectric device.

11. The powered thermal exchange system of claim 9, wherein the power supply provides power to the energy storage device through a power bus, wherein the power supply is a DC/DC converter, and wherein the power supply is coupled between the thermoelectric device and the power bus, wherein the power bus is electrically coupled between the energy storage device and the DC/DC converter.

12. The powered thermal exchange system of claim 1, further comprising a power controller configured to regulate operation of the power supply, wherein the power controller is configured to operate the power supply based on data indicative of a temperature of the energy storage device.

13. The powered thermal exchange system of claim 1, wherein the thermoelectric device includes at least:
a first mode of operation in which the thermodynamic heat is thermoelectrically transferred from the first thermal conductor to the energy storage device; and
a second mode of operation in which the thermodynamic heat is thermoelectrically transferred from the energy storage device to the first thermal conductor.

14. The powered thermal exchange system of claim 1, wherein in one mode of operation the thermoelectric device is configured to generate electrical power as a result of the thermal gradient through the thermoelectric device between the energy storage device and the first thermal conductor.

15. A powered thermal exchange system, comprising:
an energy storage device configured to transmit electrical power;
a sealed housing configured to enclose the energy storage device disposed in an interior volume of the sealed housing, the sealed housing structured to prevent transfer of fluid between the interior volume of the sealed housing and an exterior of the sealed housing; and
a thermoelectric device in conductive thermal communication with the energy storage device, the thermoelectric device structured to transfer heat between the energy storage device and the exterior of the sealed housing.

16. The powered thermal exchange system of claim 15, wherein the sealed housing is coupled with a pressure vent configured to discharge, during an over-pressure condition of the interior volume of the sealed housing, a fluid from within the interior volume of the sealed housing to the exterior of the sealed housing.

17. The powered thermal exchange system of claim 16, wherein the pressure vent is a check valve.

18. The powered thermal exchange system of claim 16, further comprising a first thermal conductor in conductive thermal communication with the exterior of the sealed housing and the thermoelectric device and a second thermal conductor in conductive thermal communication with the energy storage device and the thermoelectric device.

19. A method for thermoelectrically transferring heat, the method comprising:
providing electric power to a thermoelectric device;
transferring heat in a first mode of operation from an energy storage device through a wall of a sealed housing to a first thermal conductor as a result of a thermal gradient formed by the providing electric power to the thermoelectric device; and
removing the transferred heat from the first thermal conductor.

20. The method of claim 19, wherein the transferring includes conductively transferring the heat between the energy storage device and the first thermal conductor via the thermoelectric device.

21. The method of claim 20, further comprising conductively transferring the heat between the energy storge device and the thermoelectric device via a second thermal conductor.

22. The method of claim 21, wherein conductively transferring the heat between the energy storge device and the thermoelectric device via a second thermal conductor includes the step of transferring heat through a graphitic material.

23. The method of claim 22, wherein transferring the heat through the graphitic material includes transferring heat through a graphene ribbon positioned adjacent at least one cell of the energy storage device.
